(19) United States
(12) Patent Application Publication
(10) Pub. No.: US 2025/0057163 A1
(43) Pub. Date: Feb. 20, 2025

(54) SOLID DIAMIDE AND BIFENTHRIN FORMULATION FOR CONTROLLING INVERTEBRATE PESTS

(71) Applicants: FMC CORPORATION, Philadelphia, PA (US); FMC IP TECHNOLOGY GMBH, Neuhausen am Rheinfall (CH)

(72) Inventors: David Aarón BURGOS CÓRDOVA, Zapopan (MX); José DEL REFUGIO MUÑOZ, Zapopan (MX); Andrés GARCIA MONTERO, Zapopan (MX); Carlos Raul JURADO SYLVIA, Zapopan (MX); Luann Rue MARSHALL, Bear, DE (US)

(21) Appl. No.: 18/720,258

(22) PCT Filed: Dec. 15, 2022
(86) PCT No.: PCT/US2022/052930

§ 371 Date: Jun. 14, 2024

Related U.S. Application Data
(60) Provisional application No. 63/290,255, filed on Dec. 16, 2021.

(51) Int. Cl. A01N 43/56; A01N 25/08; A01N 25/12; A01N 25/24; A01N 25/34; A01N 53/00; A01P 7/04

(52) U.S. Cl. CPC A01N 43/56; A01N 25/08; A01N 25/12; A01N 25/24; A01N 25/34; A01N 53/00; A01P 7/04

(57) ABSTRACT

Described herein are solid formulations for controlling invertebrate pests in both agronomic and nonagronomic environments that exhibit unexpected activity. The present solid formulations show improved flowability without caking. In some aspects, the solid formulations comprise bifenthrin and a diamide pesticide.

### FIELD OF DISCLOSURE

This disclosure is directed to solid formulations for controlling invertebrate pests in both agronomic and nonagronomic environments that exhibit unexpected activity. The present solid formulations show improved flowability and reduced caking. In some aspects, the solid formulations comprise bifenthrin and a diamide pesticide.

### BACKGROUND

The control of invertebrate pests is extremely important in achieving high crop efficiency. Damage by invertebrate pests to growing and stored agronomic crops can cause significant reduction in productivity and thereby result in increased costs to the consumer. The control of invertebrate pests in forestry, greenhouse crops, ornamentals, nursery crops, stored food and fiber products, livestock, household, turf, wood products, and public and animal health is also important.

To enable the efficient elimination or control of unwanted invertebrate pests in agricultural and other applications, it is desirable to use effective chemical insecticides on these unwanted pests. Formulations containing multiple insecticides are desirable in order to broaden the spectrum of agronomically important insect and other pest species killed or controlled and take advantage of the individual pesticidal characteristics of each of the active ingredients.

Solid formulations include dusts, powders, granules, pellets, prills, pastilles and tablets. Each formulation type has advantages and disadvantages relative to other formulation types, and the optimal type for each application will depend upon the physical and biological characteristics of the active ingredient(s); the conditions of storage; and use, including pests to be controlled, plant parts or other locus to be protected, environmental conditions, etc.

Problems such as the physical stability of mixtures and unpredictable antagonism can adversely impact the efficacy associated with compositions containing multiple insecticides. When traditional insecticidal compositions are combined, the combined components (surfactants, viscosity modifiers, wetting agents, solvents) of both may cause accelerated physical degradation of the mixture. Often this problem goes unnoticed and a uniform application of the insecticide mixture is not achieved, yielding inadequate efficacy.

Solid bulk compositions often become rigid and cake during storage and handling, due to an agglomeration of free-flowing particles into lumps. Caked solids usually have low flowability, which adversely affects handling properties and the quality of even application.

A need therefore exists for solid formulations with suitable characteristics to provide the consumer with a safer, easier, faster, inexpensive, and homogeneous application. Furthermore, a need exists for solid formulations comprising bifenthrin and a diamide pesticide with suitable characteristics to provide the consumer with a safer, easier, faster, inexpensive, and homogeneous application.

### SUMMARY

Disclosed herein are solid pesticidal compositions formulated with a particularly low concentration (low strength) of pesticidal active ingredient. These compositions exhibit improved biology versus single active ingredient products, good physical handling characteristics, improved flowability and reduced caking. In addition, due to their low strength, the compositions disclosed herein can be applied without dilution and are especially well suited for soil applications and for placement in leaf whorls. The pesticidal compositions disclosed herein contribute to environmental sustainability while displaying excellent pesticidal activity.

This disclosure is directed to a solid pesticidal composition comprising bifenthrin, a diamide insecticide and optionally at least one adjuvant, wherein
(a) the weight ratio of bifenthrin to the diamide insecticide on an active ingredient basis is from about 10:1 to about 1:10; and
(b) the diamide insecticide concentration is from about 0.01 wt. % to about 10 wt. %.

This disclosure also provides a method for controlling an invertebrate pest comprising contacting the invertebrate pest or its environment with a biologically effective amount of any of the aforesaid compositions wherein the environment is a plant.

This disclosure also provides a method for controlling an invertebrate pest comprising contacting the invertebrate pest or its environment with a biologically effective amount of any of the aforesaid compositions wherein the environment is an animal.

This disclosure also provides a method for controlling an invertebrate pest comprising contacting the invertebrate pest or its environment with a biologically effective amount of any of the aforesaid compositions wherein the environment is a seed.

### DETAILED DESCRIPTION

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where applicants have defined an embodiment or a portion thereof with an open-ended term such as “comprising,” it should be readily understood that (unless otherwise stated) the description should be interpreted to also describe such an embodiment using the terms “consisting essentially of” or “consisting of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

It also is understood that any numerical range recited herein includes all values from the lower value to the upper value. For example, if a weight ratio range is stated as 1:10, it is intended that values such as 2:9, 2.5:8.1, or 1:1.6, etc., are expressly enumerated in this specification. These are only examples of what is specifically intended, and all possible combinations of numerical values between and including the lowest value and the highest value enumerated are to be considered to be expressly stated in this application. It is further understood that if a range is recited in the “from/to” or “from about/to about” format, such as from 10:1 to 1:10, the range includes the endpoints (i.e., 10:1 and 1:10).

In any of the various aspects of the disclosure, the weight ratio of bifenthrin to diamide insecticide is 10:1, 9:1, 8:1, 7:1, 6:1, 5.1, 4.9:1, 4.8:1, 4.7:1, 4.6:1, 4.5:1, 4.4:1, 4.3:1, 4.2:1, 4.1:1, 4:1, 3.9:1, 3.8:1, 3.7:1, 3.6:1, 3.5:1, 3.4:1, 3.3:1, 3.2:1, 3.1:1, 3:1, 2.9:1, 2.8:1, 2.7:1, 2.6:1, 2.5:1, 2.4:1, 2.3:1, 2.2:1, 2.1:1, 2:1, 1.9:1, 1.8:1, 1.7:1, 1.6:1, 1.4:1, 1.3:1, 1.2:1, 1.1:1, 1:1, 1:1.1, 1:1.2, 1:1.3, 1:1.4, 1:1.5, 1:1.6, 1:1.7, 1:1.8, 1:1.9, 1:2, 1:2.1, 1:2.2, 1:2.3, 1:2.4, 1:2.5, 1:2.6, 1:2.7, 1:2.8, 1:2.9, 1:3, 1:3.1, 1:3.2, 1:3.3, 1:3.4, 1:3.5, 1:3.6, 1:3.7, 1:3.8, 1:3.9, 1:4, 1:4.1, 1:4.2, 1:4.3, 1:4.4, 1:4.5, 1:4.6, 1:4.7, 1:4.8, 1:4.9, 1:5, 1:6, 1:7, 1:8, 1:9 or 1:10, and any range constructed therefrom, such as from about 5:1 to about 1:1, from about 3:1 to about 1:1, from about 2.1:1 to about 1.1:1, from about 1.9:1 to about 1.3:1, or from about 1.7:1 to about 1.5:1.

In some embodiments, the diamide insecticide active ingredient is present in an amount of about 0.01 wt %, about 0.05 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, about 0.50 wt %, about 1.0 wt %, about 5.0 wt %, or about 10 wt %, and ranges constructed therefrom, such as from about 0.01 wt % to about 10 wt %, from about 0.01 wt % to about 5.0 wt %, from about 0.01% to about 2.0 wt %, from about 0.10 wt % to about 1.0 wt %, from about 0.10 wt % to about 0.50 wt %, from about 0.10 wt % to about 0.40 wt %, from about 0.20 wt % to about 0.30 wt %, from about 0.19 wt % to about 0.31 wt %, or from about 0.21 wt % to about 0.29 wt %. In one embodiment, the diamide insecticide active ingredient is present in low strength. Amounts of a diamide insecticide active ingredient in a low strength include, but are not limited to, less than 10 wt %, less than 5 wt %, or less than 1 wt %. In one embodiment, a low strength amount of a diamide insecticide active ingredient is less than 1 wt %.

In some embodiments, the bifenthrin active ingredient is present in an amount of about 0.01 wt %, about 0.05 wt %, about 0.10 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, about 0.50 wt %, about 0.51 wt %, about 0.52 wt %, about 0.53 wt %, about 0.54 wt %, about 0.55 wt %, about 0.56 wt %, about 0.57 wt %, about 0.58 wt %, about 0.59 wt %, about 0.60 wt %, about 0.65 wt %, about 0.70 wt %, about 1.0 wt %, about 5.0 wt %, or about 10 wt %, and ranges constructed therefrom, such as from about 0.01 wt % to about 10 wt %, from about 0.02 wt % to about 8.0 wt %, from about 0.02% to about 3.20 wt %, from about 0.10 wt % to about 1.0 wt %, from about 0.16 wt % to about 0.80 wt %, from about 0.20 wt % to about 0.60 wt %, from about 0.25 wt % to about 0.55 wt %, from about 0.30 wt % to about 0.50 wt %, or from about 0.35 wt % to about 0.45 wt %. In one embodiment, the bifenthrin active ingredient is present in low strength. Amounts of a bifenthrin active ingredient in a low strength include, but are not limited to, less than 10 wt %, less than 5 wt %, or less than 1 wt %. In one embodiment, a low strength amount of a bifenthrin active ingredient is less than 1 wt %.

In some aspects, the compositions of the present disclosure may further comprise one or more adjuvants as defined elsewhere herein.

The term “adjuvant” refers to materials that are added to compositions of the present disclosure to enhance the efficacy of active ingredients and/or improve the overall performance of the product. Adjuvants include, but are not limited to rheology modifiers (e.g., thickeners), drying agents, anticaking agents, solvents, wetting agents, dispersants, sticking agents, emulsifiers, surfactants, defoaming agents, solvents, carriers, diluents, oils, pH modifiers, sticking agents, buffers, efficacy enhancers, biocides, antifreeze, and 10 combinations thereof. Suitable adjuvants and other additives are described for example in McCutcheon's, Volume 2: Functional Materials published by MC Publishing Company annually.

Suitable solid carriers in the context of the present disclosure are a particulate component that may be penetrated as well as coated with a mixture comprising an insecticidally active ingredient(s) and at least one adjuvant. When penetrated, the mixture is absorbed into pores in the solid carrier. The pores can be in the form of channels or other cavities in the solid carrier particles, but must be open to the exterior of the particles to allow infiltration of the mixture into the particles during composition manufacture, and then later allow egress of the mixture into the soil, a leaf cuticle, seed testa or other contacted plant part without needing to disrupt the solid carrier. The solid carrier is primarily intended to provide support, and the material of the solid carrier itself generally does not comprise bifenthrin, a diamide insecticide and at least one adjuvant. Examples of suitable solid carriers include, but are not limited to, sand, clays, crushed marble, talc, ground corncob, wood flours, activated carbon, diatomaceous earth, fine-grain inorganic solids, calcium carbonate and woodchips.

To facilitate the application of an insecticidally active ingredient to the solid carrier, a suitable solvent or mixture of solvents may be used. Suitable solvents are those in which an insecticidally active ingredient of this disclosure are soluble and stable. In one embodiment, a suitable solvent is capable of dissolving a desired amount of bifenthrin. In some embodiments, the solvent is selected from the group consisting of alcohols, alkenes, alkanes, alkynes, phenols, hydrocarbons, chlorinated hydrocarbons, ketones, water, ethers and combinations thereof. Further examples of solvents include, but are not limited to, aliphatic solvents such as de-aromatized hydrocarbon fluids, for example, Exxsol D series fluids (available from ExxonMobile Chemicals), isoparaffinic fluids, for example Isopar fluids (available from ExxonMobile Chemicals), and hydrocarbon fluids with very high normal paraffin content, for example, Norpar fluids (available from ExxonMobile Chemicals). In one embodiment, the solvent is selected from the group consisting of hydrotreated light petroleum distillates and hydrotreated medium petroleum distillates.

The concentration of the solvent component in the solid compositions of the present disclosure may be about 0.01 wt %, about 0.05 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, about 0.50 wt %, about 0.51 wt %, about 0.52 wt %, about 0.53 wt %, about 0.54 wt %, about 0.55 wt %, about 0.56 wt %, about 0.57 wt %, about 0.58 wt %, about 0.59 wt %, about 0.60 wt %, about 1.0 wt %, or about 5.0 wt %, and ranges constructed therefrom, such as from about 0.01 wt % to about 5.0 wt %, from about 0.01 wt % to about 3.0 wt %, from about 0.01% to about 1.0 wt %, from about 0.10 wt % to about 1.0 wt %, from about 0.15 wt % to about 0.80 wt %, from about 0.15 wt % to about 0.60 wt %, from about 0.15 wt % to about 0.50 wt %, from about 0.25 wt % to about 0.50 wt %, from about 0.25 wt % to about 0.45 wt %, from about 0.25 wt % to about 0.40 wt %, or from about 0.20 wt % to about 0.40 wt %.

Sticking agents (alternatively identified as stickers, adhesive agents and adhesives) in the context of the present disclosure may be used to adhere the insecticidally active ingredient(s) to the solid carrier. Examples of sticking agents include, but are not limited to, acrylic acids, copolymers of acrylic acid and salts thereof, polyacrylic acid, polymethacrylic acid, polymaleic acid, polymaleic anhydride, a copolymer of maleic acid or maleic anhydride with an olefin (such as isobutylene or diisobutylene), a copolymer of acrylic acid and itaconic acid, a copolymer of methacrylic acid and itaconic acid, a copolymer of maleic acid or maleic anhydride and styrene, a copolymer of acrylic acid and methacrylic acid, a copolymer of acrylic acid and methacrylate, a copolymer of acrylic acid and vinyl acetate, a copolymer of styrene and methacrylic acid, modified copolymers of styrene and methacrylic acid, a copolymer of maleic acid or maleic anhydride and acrylic acid, an N-methyl fatty acid (e.g. C₈-C₁₈) sarcosinate, a carboxylic acid such as a resin acid or a fatty acid (e.g. C₈-C₁₈) or a salt of such a carboxylic acid. The above-mentioned copolymers may also be in the form of their salts, e.g. alkali metal salts, alkaline earth metal salts, ammonium or various amines. Further examples of sticking agents include, but are not limited to, polyvinyl acetates, polyvinyl acetate copolymers, hydrolyzed polyvinyl acetates, polyvinyl pyrrolidone vinyl acetate copolymer, polyethylene oxide, polyvinyl alcohols, polyvinyl alcohol copolymers, polyvinyl methyl ether, polyvinyl methyl ether-maleic anhydride copolymer, waxes, latex polymers, celluloses including ethylcelluloses and methylcelluloses, hydroxymethylcelluloses, hydroxypropylcellulose, hydroxymethylpropylcelluloses, poly-vinylpyrrolidones, alginates, dextrins, maltodextrins, polysaccharides, fats, oils, proteins, karaya gum, jaguar gum, tragacanth gum, polysaccharide gums, mucilage, gum arabics, shellacs, vinylidene chloride polymers and copolymers, soybean-based protein polymers and copolymers, lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof.

The concentration of the sticking agent in the solid compositions of the present disclosure may be about 0.01 wt %, about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.45 wt %, 0.50 wt %, about 1.0 wt %, or about 5.0 wt %, and ranges constructed therefrom, such as from about 0.01 wt % to about 5.0 wt %, from about 0.01 wt % to about 3.0 wt %, from about 0.01% to about 1.0 wt %, from about 0.05% to about 1.0 wt %, from about 0.05 wt % to about 0.50 wt %, from about 0.05 wt % to about 0.30 wt %, from about 0.05 wt % to about 0.25 wt %, from about 0.10 wt % to about 0.25 wt %, or from about 0.10 wt % to about 0.20 wt %.

Drying agents (alternatively identified as absorbants) can absorb any exposed solvent as well as coat over any surface stickiness. Drying agents include, but are not limited to, calcium silicate, calcium carbonate, talc, kaolin, bentonite, diatomaceous earth, silica, fumed silica, precipitated silica, colloidal silica, amorphous silica, sodium aluminosilicate, microcrystalline cellulose and attapulgite clay. As used herein, the term “silica” refers to a solid chemical substance consisting mostly (e.g., at least 90 or 95% by weight) of silicon and oxygen atoms in a ratio of about two oxygen atoms to one silicon atom, thus having the empirical formula of SiO₂. Silicas include, for example, precipitated silicas, fumed silicas, amorphous silicas, diatomaceous silicas (also known as diatomaceous earths) as well as silanized forms of these silicas. The term “silicate” refers to a solid chemical substance consisting mostly (e.g., at least 90 or 95% by weight) of atoms of silicon, oxygen and at least one metal (e.g., lithium, sodium, potassium, magnesium, calcium, aluminum).

The concentration of the drying agent in the solid compositions of the present disclosure may be about 0.01 wt %, about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, about 0.50 wt %, about 0.51 wt %, about 0.52 wt %, about 0.53 wt %, about 0.54 wt %, about 0.55 wt %, about 1.0 wt %, or about 5.0 wt %, and ranges constructed therefrom, such as from about 0.01 wt % to about 5.0 wt %, from about 0.01 wt % to about 3.0 wt %, from about 0.01% to about 1.0 wt %, from about 0.05% to about 1.0 wt %, from about 0.05 wt % to about 0.50 wt %, from about 0.05 wt % to about 0.40 wt %, from about 0.05 wt % to about 0.35 wt %, from about 0.10 wt % to about 0.35 wt %, or from about 0.10 wt % to about 0.30 wt %.

In the context of this disclosure “invertebrate pest control” means inhibition of invertebrate pest development (including mortality, feeding reduction, and/or mating disruption), and related expressions are defined analogously.

The term “crop vigor” refers to rate of growth or biomass accumulation of a crop plant. An “increase in vigor” refers to an increase in growth or biomass accumulation in a crop plant relative to an untreated control crop plant. The term “crop yield” refers to the return on crop material, in terms of both quantity and quality, obtained after harvesting a crop plant. An “increase in crop yield” refers to an increase in crop yield relative to an untreated control crop plant.

The term “biologically effective amount” refers to the amount of a biologically active composition of the disclosure sufficient to produce the desired biological effect when applied to (i.e. contacted with) an invertebrate pest to be controlled or its environment, or to a plant, the seed from which the plant is grown, or the locus of the plant (e.g., growth medium) to protect the plant from injury by the invertebrate pest or for other desired effect (e.g., increasing plant vigor).

As referred to in this disclosure, the term “invertebrate pest” includes arthropods, gastropods, nematodes and helminths of economic importance as pests. The term “arthropod” includes insects, mites, spiders, scorpions, centipedes, millipedes, pill bugs and symphylans. The term “gastropod” includes snails, slugs and other Stylommatophora. The term “nematode” includes members of the phylum Nematoda, such as phytophagous nematodes and helminth nematodes parasitizing animals. The term “helminth” includes all of the parasitic worms, such as roundworms (phylum Nematoda), heartworms (phylum Nematoda, class Secernentea), flukes (phylum Platyhelminthes, class Tematoda), acanthocephalans (phylum Acanthocephala), and tapeworms (phylum Platyhelminthes, class Cestoda).

Phytophagous insects refers to invertebrate pests causing injury to plants by feeding upon them, such as by eating foliage, stem, leaf, fruit or seed tissue or by sucking the vascular juices of plants. Leaf feeders may be external (exophytic) or they may mine the tissues, sometimes even specializing on a particular cell type. There are phytophagous insect species in the majority of insect orders, including Hemiptera, Thysanoptera, Orthoptera, Lepidoptera, Coleoptera, Heteroptera, Hymenoptera, and Diptera.

Examples of agronomic or nonagronomic invertebrate pests include eggs, larvae and adults of the order Lepidoptera, such as armyworms, cutworms, loopers, and heliothines in the family Noctuidae (e.g., pink stem borer (Sesamia inferens Walker), corn stalk borer (Sesamia nonagrioides Lefebvre), southern armyworm (Spodoptera eridania Cramer), fall armyworm (Spodoptera frugiperda J. E. Smith), beet armyworm (Spodoptera exigua Hübner), cotton leafworm (Spodoptera littoralis Boisduval), yellowstriped armyworm (Spodoptera ornithogalli Guenée), black cutworm (Agrotis ipsilon Hufnagel), velvetbean caterpillar (Anticarsia gemmatalis Hübner), green fruitworm (Lithophane antennata Walker), cabbage armyworm (Barathra brassicae Linnaeus), soybean looper (Pseudoplusia includens Walker), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworms (Pyralidae: Crambinae) such as sod worm (Herpetogramma licarsisalis Walker), sugarcane stem borer (Chilo infuscatellus Snellen), tomato small borer (Neoleucinodes elegantalis Guenée), green leafroller (Cnaphalocrocis medinalis), grape leaffolder (Desmia funeralis Hübner), melon worm (Diaphania nitidalis Stoll), cabbage center grub (Helluala hydralis Guenée), yellow stem borer (Scirpophaga incertulas Walker), early shoot borer (Scirpophaga infuscatellus Snellen), white stem borer (Scirpophaga innotata Walker), top shoot borer (Scirpophaga nivella Fabricius), dark-headed rice borer (Chilo polychrysus Meyrick), striped riceborer (Chilo suppressalis Walker), cabbage cluster caterpillar (Crocidolomia binotalis English)); leafrollers, budworms, seed worms, and fruit worms in the family Tortricidae (e.g., codling moth (Cydia pomonella Linnaeus), grape berry moth (Endopiza viteana Clemens), oriental fruit moth (Grapholita molesta Busck), citrus false codling moth (Cryptophlebia leucotreta Meyrick), citrus borer (Ecdytolopha aurantiana Lima), redbanded leafroller (Argyrotaenia velutinana Walker), obliquebanded leafroller (Choristoneura rosaceana Harris), light brown apple moth (Epiphyas postvittana Walker), European grape berry moth (Eupoecilia ambiguella Hübner), apple bud moth (Pandemis pyrusana Kearfott), omnivorous leafroller (Platynota stultana Walsingham), barred fruit-tree tortrix (Pandemis cerasana Hübner), apple brown tortrix (Pandemis heparana Denis & Schiffermüller)); and many other economically important lepidoptera (e.g., diamond back moth (Plutella xylostella Linnaeus), pink bollworm (Pectinophora gossypiella Saunders), gypsy moth (Lymantria dispar Linnaeus), peach fruit borer (Carposina niponensis Walsingham), peach twig borer (Anarsia lineatella Zeller), potato tuberworm (Phthorimaea operculella Zeller), spotted teniform leafminer (Lithocolletis blancardella Fabricius), Asiatic apple leafminer (Lithocolletis ringoniella Matsumura), rice leaffolder (Lerodea eufala Edwards), apple leafminer (Leucoptera scitella Zeller)); eggs, nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fabricius)), smoky brown cockroach (Periplaneta fuliginosa Service), Australian Cockroach (Periplaneta australasiae Fabr.), lobster cockroach (Nauphoeta cinerea Olivier) and smooth cockroach (Symploce pallens Stephens)); eggs, foliar feeding, fruit feeding, root feeding, seed feeding and vesicular tissue feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus)), annual bluegrass weevil (Listronotus maculicollis Dietz), bluegrass billbug (Sphenophorus parvulus Gyllenhal), hunting billbug (Sphenophorus venatus vestitus), Denver billbug (Sphenophorus cicatristriatus Fahraeus)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera LeConte)); chafers and other beetles from the family Scarabaeidae (e.g., Japanese beetle (Popillia japonica Newman), oriental beetle (Anomala orientalis Waterhouse, Exomala orientalis (Waterhouse) Baraud), northern masked chafer (Cyclocephala borealis Arrow), southern masked chafer (Cyclocephala immaculata Olivier or C. lurida Bland), dung beetle and white grub (Aphodius spp.), black turfgrass ataenius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowsky)); carpet beetles from the family Dermestidae; wireworms from the family Elateridae; bark beetles from the family Scolytidae and flour beetles from the family Tenebrionidae.

In addition, agronomic and nonagronomic pests include: eggs, adults and larvae of the order Dermaptera including earwigs from the family Forficulidae (e.g., European earwig (Forficula auricularia Linnaeus), black earwig (Chelisoches morio Fabricius)); eggs, immatures, adults and nymphs of the orders Hemiptera and Homoptera such as, plant bugs from the family Miridae, cicadas from the family Cicadidae, leafhoppers (e.g. Empoasca spp.) from the family Cicadellidae, potato leafhoppers, bed bugs (e.g., Cimex lectularius Linnaeus) from the family Cimicidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, chinch bugs (e.g., hairy chinch bug (Blissus leucopterus hirtus Montandon) and southern chinch bug (Blissus insularis Barber)) and other seed bugs from the family Lygaeidae, spittlebugs from the family Cercopidae squash bugs from the family Coreidae, and red bugs and cotton stainers from the family Pyrrhocoridae.

Agronomic and nonagronomic pests also include: eggs, larvae, nymphs and adults of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)); flat mites in the family Tenuipalpidae (e.g., citrus flat mite (Brevipalpus lewisi McGregor)); rust and bud mites in the family Eriophyidae and other foliar feeding mites and mites important in human and animal health, i.e. dust mites in the family Epidermoptidae, follicle mites in the family Demodicidae, grain mites in the family Glycyphagidae; ticks in the family Ixodidae, commonly known as hard ticks (e.g., deer tick (Ixodes scapularis Say), Australian paralysis tick (Ixodes holocyclus Neumann), American dog tick (Dermacentor variabilis Say), lone star tick (Amblyomma americanum Linnaeus)) and ticks in the family Argasidae, commonly known as soft ticks (e.g., relapsing fever tick (Ornithodoros turicata), common fowl tick (Argas radiatus)); scab and itch mites in the families Psoroptidae, Pyemotidae, and Sarcoptidae; eggs, adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria Linnaeus), bush locust (Zonocerus spp.), house cricket (Acheta domesticus Linnaeus), mole crickets (e.g., tawny mole cricket (Scapteriscus vicinus Scudder) and southern mole cricket (Scapteriscus borellii Giglio-Tos)); eggs, adults and immatures of the order Diptera including leafminers (e.g., Liriomyza spp. such as serpentine vegetable leafminer (Liriomyza sativae Blanchard)), midges, fruit flies (Tephritidae), frit flies (e.g., Oscinella frit Linnaeus), soil maggots, house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera; eggs, adults and immatures of the order Thysanoptera including onion thrips (Thrips tabaci Lindeman), flower thrips (Frankliniella spp.), and other foliar feeding thrips; insect pests of the order Hymenoptera including ants of the Family Formicidae including the Florida carpenter ant (Camponotus floridanus Buckley), red carpenter ant (Camponotus ferrugineus Fabricius), black carpenter ant (Camponotus pennsylvanicus De Geer), white-footed ant (Technomyrmex albipes fr. Smith), big headed ants (Pheidole sp.), ghost ant (Tapinoma melanocephalum Fabricius); Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster) and odorous house ant (Tapinoma sessile Say). Other Hymenoptera including bees (including carpenter bees), hornets, yellow jackets, wasps, and sawflies (Neodiprion spp.; Cephus spp.); insect pests of the order Isoptera including termites in the Termitidae (e.g., Macrotermes sp., Odontotermes obesus Rambur), Kalotermitidae (e.g., Cryptotermes sp.), and Rhinotermitidae (e.g., Reticulitermes sp., Coptotermes sp., Heterotermes tenuis Hagen) families, the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus).

Examples of invertebrate pests of stored grain include larger grain borer (Prostephanus truncatus), lesser grain borer (Rhyzopertha dominica), rice weevil (Stiophilus oryzae), maize weevil (Stiophilus zeamais), cowpea weevil (Callosobruchus maculatus), red flour beetle (Tribolium castaneum), granary weevil (Stiophilus granarius), Indian meal moth (Plodia interpunctella), Mediterranean flour beetle (Ephestia kuhniella) and flat or rusty grain beetle (Cryptolestis ferrugineus).

Compositions of the present disclosure may have activity on members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e. root knot nematodes in the genus Meloidogyne, lesion nematodes in the genus Pratylenchus, stubby root nematodes in the genus Trichodorus, etc.) and animal and human health pests (i.e. all economically important flukes, tapeworms, and roundworms, such as Strongylus vulgaris in horses, Toxocara canis in dogs, Haemonchus contortus in sheep, Dirofilaria immitis Leidy in dogs, Anoplocephala perfoliata in horses, Fasciola hepatica Linnaeus in ruminants, etc.).

Compositions of the disclosure may have activity against pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guenée (rice leaf roller), Crambus caliginosellus Clemens (corn root webworm), Crambus teterrellus Zincken (bluegrass webworm), Cydia pomonella Linnaeus (codling moth), Farias insulana Boisduval (spiny bollworm), Farias vittella Fabricius (spotted bollworm), Helicoverpa armigera Hübner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermüller (grape berry moth), Pectinophora gossypiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamond back moth), Spodoptera exigua Hübner (beet armyworm), Spodoptera litura Fabricius (tobacco cutworm, cluster caterpillar), Spodoptera frugiperda J. E. Smith (fall armyworm), Trichoplusia ni Hübner (cabbage looper) and Tuta absoluta Meyrick (tomato leafminer)).

Compositions of the disclosure may have significant activity on members from the order Homoptera including: Acyrthosiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosiphum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stål (rice leafhopper), Nilaparvata lugens Stål (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla).

Compositions of this disclosure also may have activity on members from the order Hemiptera including: Acrosternum hilare Say (green stink bug), Anasa tristis De Geer (squash bug), Blissus leucopterus Say (chinch bug), Cimex lectularius Linnaeus (bed bug) Corythuca gossypii Fabricius (cotton lace bug), Cyrtopeltis modesta Distant (tomato bug), Dysdercus suturellus Herrich-Schäffer (cotton stainer), Euchistus servus Say (brown stink bug), Euchistus variolarius Palisot de Beauvois (one-spotted stink bug), Graptosthetus spp. (complex of seed bugs), Halymorpha halys Stål (brown marmorated stink bug), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the disclosure include Thysanoptera (e.g., Frankliniella occidentalis Pergande (western flower thrips), Scirthothrips citri Moulton (citrus thrips), Sericothrips variabilis Beach (soybean thrips), and Thrips tabaci Lindeman (onion thrips); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

In some aspects, the compositions of the disclosure are useful for controlling Western Flower Thrips (Frankliniella occidentalis). In some aspects, the compositions of the disclosure are useful for controlling potato leafhopper (Empoasca fabae). In some aspects, the compositions of the disclosure are useful for controlling cotton melon aphid (Aphis gossypii). In some aspects, the compositions of the disclosure are useful for controlling diamond backmoth (Plutella xylostella L.). In some aspects, the compositions of the disclosure are useful for controlling Silverleaf Whitefly (Bemisia argentifolii Bellows & Perring).

In cyantraniliprole aspects of the disclosure, the compositions of the disclosure are effective against Coleoptera, Chrysomelidae, Cerotoma trifurcata bean leaf beetle, Chaetocnema concinna beet flea beetle, Epilachna varivestis Mexican bean beetle, Epitrix cucumeris potato flea beetle, Leptinotarsa decemlineata Colorado potato beetle, Oulema melanopus cereal leaf beetle, Oulema oryzae rice leaf beetle, Phyllotreta cruciiferae cabbage flea beetle, Phyllotreta striolata striped flea beetle, Psylliodes spp. flea beetles, Curculionidae, Anthonomus eugenii pepper weevil, Ceutorhynchus napi cabbage stem weevil, Ceutorhynchus quadridens cabbage seed-stalk curculio, Conotrachelus nenuphar plum curculio, Hypera bruneipennis Egyptian alfalfa weevil, Hypera postica alfalfa weevil, Lissorhoptrus oryzophilus rice water weevil, Nitidulidae, Meligethes aeneus pollen beetle, blossom beetle, Scarabaeidae, Cotinis nitida green June beetle, Phyllophaga spp. June beetles, grubs, Popillia japonica Japanese beetle, Diptera, Agromyzidae, Liromyza chinensis stone leek leafminer, Liromyza huidobrensis pea leafminer, Liriomyza sativae serpentine/vegetable leafminer, Liromyza trifolii American serpentine leafminer, Anthomyiidae, Delia antiqua onion fly, Delia platura seedcorn maggot, Muscidae, Atherigona oryzae rice seedling fly, Psilidae, Psila rosae carrot fly, Tephritidae, Anastrepha fraterculus South American fruit fly, Anastrepha ludens Mexican fruit fly, Anasterpha striata guava fruit fly, Bactrocera cucurbitae melon fly, Bactrocera dorsalis oriental fruit fly, Bactrocera oleae olive fly, Ceratitis capitata Mediterranean fruit fly, Chromatomyia horticola garden pea leafminer, Rhagoletis cerasi cherry fruit fly, Rhagoletis cingulata cherry fruit fly, Rhagoletis indifferens western cherry fruit fly, Rhagoletis pomonella apple maggot, Hemiptera, Aleyrodidae, Aleyrodes proletella cabbage whitefly, Bemisia tabaci sweet potato whitefly, cotton whitefly, Dialeurodes citri citrus whitefly, Trialeurodes vaporariorum, greenhouse whitefly, Aphididae, Acyrthosiphon pisum pea aphid, Aphis craccivora cowpea aphid, Aphis fabae black bean aphid, Aphis glycines soybean aphid, Aphis gossypii cotton aphid, melon aphid, Aphis nasturtii buckthorn aphid, Aphis pomi green apple aphid, Aphis spiraceola spirea aphid, Aulacorthum solani foxglove aphid, Brachycaudus persicae black peach aphid, Brevicoryne brassicae cabbage aphid, Chromaphis juglandicola European walnut aphid, Dysaphis plantaginea rosy apple aphid, Hyalopterus pruni mealy plum aphid, Lipaphis erysimi mustard aphid, turnip aphid, Macrosiphum euphorbiae potato aphid, Myzus persicae green peach aphid, peach potato aphid, Rhopalosiphum padi bird cherry oat aphid, Rhopalosiphum nymphaeae plum aphid, Schizaphis graminum greenbug, Sitobion avenae English grain aphid, Therioaphis maculata spotted alfalfa aphid, Toxoptera citricida brown citrus aphid, oriental citrus aphid, Cicadellidae, Empoasca fabae leafhopper/jassid complex, Empoasca vitis green frogfly, Hortensia similis common green leafhopper, Idioscopus spp. mango leafhopper, Jacobiasca lybica cotton jassid, Nephotettix spp. rice green leafhopper complex, Typhlocyba rosae rose leafhopper, Typhlocyba pomaria white apple leafhopper, Coreidae Leptocorisa oratorius rice bug, rice ear bug, paddy bug, Delphacidae, Nilaparvata lugens rice brown planthopper, Diaspididae, Aonidiella aurantii citrus scale, Flatidae, Metcalfa pruinosa citrus flatid planthopper, Pentatomidae, Euschistus spp. brown stinkbugs, Edessa spp. stink bugs, Psyllidae, Diaphorina citri Asian citrus psyllid, Paratrioza cockerelli potato psyllid, tomato psyllid, Trioza eugeniae eugenia psyllid, lillypilly psyllid, Hymenoptera Tenthredinidae, Hoplocampa testudinea European apple sawfly, Lepidoptera, Crambidae, Scirpophaga incertulas yellow (rice) stemborer, Gelechiidae, Anarsia lineatella peach twig borer, Keiferia lycopersicella tomato pinworm, Pectinophora gossypiella pink bollworm, Tuta absoluta tomato leafminer, Gracillariidae, Gracillaria theivora tea leafroller, Phyllonorycter blancardella spotted tentiform leafminer, Phyllonorycter coryfoliella nut leaf blister moth, Phyllonorycter crataegella apple blotch leafminer, Phyllonorycter ringoniella apple leafminer, Phyllonorycter elmaella western tentiform leafminer, Hesperiidae, Borbo cinara rice leafroller, Lyonetiidae, Leucoptera coffeella white coffee leafminer, Leucoptera scitella pear leaf blister moth, Lyonetia clerkella peach, leaf miner, Noctuidae, Agrotis segetum common cutworm, Alabama argillacea cotton leafworm, Autographa californica alfalfa looper, Barathra brassicae cabbage armyworm, Chrysodeixis chalcites green garden looper, Chrysodeixis eriosoma green semi-looper, Earias insulana Egyptian bollworm, Earias vittella northern rough bollworm, Feltia subterranea granulate cutworm, Helicoverpa armigera American bollworm, cotton bollworm, Helicoverpa punctigera climbing cutworm, Heliothis virescens tobacco budworm, Helicoverpa zea corn earworm, Prodenia ornithogalli yellow-striped armyworm, Pseudaletia unipuncta true armyworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistidae, Phyllocnistis citrella citrus leafminer, Pieridae, Colias eurytheme alfalfa caterpillar, Leptophobia aripa green-eyed white, Pieris brassicae cabbage butterfly, large white, Pieris rapae imported cabbage worm, cabbage white, Plutellidae, Plutella xylostella diamondback moth, Pyralidae, Chilo suppressalis Asiatic rice stemborer, Cnaphalocerus medinalis rice leaffolder, Crocidolomia binotalis cabbage caterpillar, Desmia funeralis grape leaffolder, Diaphania indica cotton caterpillar, Diaphania nitidaltis melonworm, Hellula hydralis cabbage center grub, Hellula undalis cabbage webworm, Lerodea eufala rice leaffolder, Leucinodes orbonalis brinjal fruit borer, Maruca testulalis bean pod borer, Neoleucinodes elegantalis small tomato borer, Nymphula depunctalis rice caseworm, Ostrinia furnicalis Asian corn borer, Ostrinia nubilalis European corn borer, Sphingidae, Manduca sexta tomato hornworm, tobacco hornworm, Smerinthus spp. sphinx moths, Tortricidae, Adoxophyes orana summer fruit tortrix, Argyrotaenia pulchellana grape tortrix, Argyrotaenia velutinana red-banded leafroller, Choristoneura rosaceana oblique-banded leafroller, Eupoecilia ambiguella grape berry moth, Cydia pomonella codling moth, Cydia prunivora lesser apple worm, Grapholita molesta oriental fruit moth, Lobesia botrana grape vine moth, Pandemis heparana apple brown tortrix, Pandemis limitata three-lined leaf roller, Paramyelois transitella navel orangeworm, Platynota idaeusalis tufted apple bud moth, Platynota stultana omnivorus leafroller, Thysanoptera, Thripidae, Enneothrips flavens, Frankliniella fusca tobacco thrips, Frankliniella intonsa European flower thrips, Frankliniella occidentalis western flower thrips, Frankliniella schultzei common blossom thrips, Frankliniella tritici eastern flower thrips, Megalurothrips sjostedti cowpea thrips, Megalurothrips usitatus bean blossom thrips, Scirthothrips citri citrus thrips, Scirthothrips dorsalis yellow tea thrips, chilli thrips, Sericothrips variabilis soybean thrips, Stenchaetothrips biformis oriental rice thrips, Thrips arizonensis cotton thrips, Thrips meridionalis peach thrips, Thrips palmi melon thrips, and Thrips tabaci onion thrips, common cotton thrips.

In some cyantraniliprole aspects, of the disclosure, the compositions of the disclosure are effective against Leptinotarsa decemlineata Colorado potato beetle, Oulema oryzae rice leaf beetle, Phyllotreta cruciiferae cabbage flea beetle, Phyllotreta striolata striped flea beetle, Psylliodes spp. flea beetles, Anthonomus eugenii pepper weevil, Conotrachelus nenuphar plum curculio, Lissorhoptrus oryzophilus rice water weevil, Meligethes aeneus pollen beetle, blossom beetle, Liromyza chinensis stone leek leafminer, Liromyza huidobrensis pea leafminer, Liriomyza sativae serpentine/vegetable leafminer, Liromyza trifolii American serpentine leafminer, Delia antiqua onion fly, Delia platura seedcorn maggot, Psila rosae carrot fly, Bactrocera dorsalis oriental fruit fly, Bactrocera oleae olive fly, Ceratitis capitata Mediterranean fruit fly, Rhagoletis indifferens western cherry fruit fly, Rhagoletis pomonella apple maggot, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis fabae black bean aphid, Aphis gossypii cotton aphid, melon aphid, Aphis pomi green apple aphid, Aphis spiraceola spirea aphid, Aulacorthum solani foxglove aphid, Brevicoryne brassicae cabbage aphid, Dysaphis plantaginea rosy apple aphid, Lipaphis erysimi mustard aphid, turnip aphid, Macrosiphum euphorbiae potato aphid, Myzus persicae green peach aphid, peach potato aphid, Rhopalosiphum padi bird cherry oat aphid, Schizaphis graminum greenbug, Sitobion avenae English grain aphid, Toxoptera citricida brown citrus aphid, oriental citrus aphid, Empoasca vitis green frogfly, Idioscopus spp. mango leafhopper, Nilaparvata lugens rice brown planthopper, Aonidiella aurantii citrus scale, Euschistus spp. brown stinkbugs, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea corn earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistis citrella citrus leafminer, Pieris brassicae cabbage butterfly, large white, Pieris rapae imported cabbage worm, cabbage white, Plutella xylostella diamondback moth, Chilo suppressalis Asiatic rice stemborer, Cnaphalocerus medinalis rice leaffolder, Leucinodes orbonalis brinjal fruit borer, Ostrinia furnicalis Asian corn borer, Ostrinia nubilalis European corn borer, Choristoneura rosaceana oblique-banded leafroller, Eupoecilia ambiguella grape berry moth, Cydia pomonella codling moth, Grapholita molesta oriental fruit moth, Lobesia botrana grape vine moth, Frankliniella fusca tobacco thrips, Frankliniella intonsa European flower thrips, Frankliniella occidentalis western flower thrips, Scirthothrips citri citrus thrips, Scirthothrips dorsalis yellow tea thrips, chilli thrips, Thrips palmi melon thrips, and Thrips tabaci onion thrips, common cotton thrips.

In some cyantraniliprole aspects of the disclosure, the compositions of the disclosure are effective against Conotrachelus nenuphar plum curculio, Liromyza huidobrensis pea leafminer, Liriomyza sativae serpentine/vegetable leafminer, Liromyza trifolii American serpentine leafminer, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis gossypii cotton aphid, melon aphid, Brevicoryne brassicae cabbage aphid, Dysaphis plantaginea rosy apple aphid, Myzus persicae green peach aphid, peach potato aphid, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea corn earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Phyllocnistis citrella citrus leafminer, Plutella xylostella diamondback moth, Chilo suppressalis Asiatic rice stemborer, Cnaphalocerus medinalis rice leaffolder, Choristoneura rosaceana oblique-banded leafroller, Eupoecilia ambiguella grape berry moth, Cydia pomonella codling moth, Grapholita molesta oriental fruit moth, Lobesia botrana grape vine moth, Frankliniella fusca tobacco thrips, Frankliniella occidentalis western flower thrips, Scirthothrips dorsalis yellow tea thrips, chilli thrips, Thrips palmi melon thrips, and Thrips tabaci onion thrips, common cotton thrips.

In chlorantraniliprole aspects of the disclosure, the compositions of the disclosure are effective against: Coleoptera (Chrysomelida, Leptinotarsa decemlineata Colorado potato beetle, Curculionidae, Lissorhoptrus oryzophilus rice water weevil, Listronotus maculicollis annual bluegrass weevil, Oryzophagus oryzae rice water weevil, Sphenophorus spp. Billbug, Scarabaeidae Ataenius spretulus black turfgrass ataenius, Aphodius spp. scarab beetles, Cotinis nitida green June beetle, Cyclocephala spp. masked chafers, Exomala orientalis oriental beetle grub, Maladera castanea Asiatic garden beetle, Phyllophaga spp. June beetles, Popillia japonica Japanese beetle, and Rhizotrogus majalis European chafer); Diptera (Agromyzidae, Chromatomyia horticola garden pea leafminer, and Liriomyza spp. Leafminers); Hemiptera (Aleyrodidae, Bemisia spp. Whitefly, Trialeurodes abutiloneus bandedwinged whitefly, Cicadellidae, and Typhlocyba pomaria white apple leafhopper); Isoptera (Rhinotermitidae, Heterotermes tenuis sugarcane termite, Termitidae, Microtermes obesi sugarcane termite, and Odontotermes obesus sugarcane termite); and Lepidoptera (Arctiidae, Estigmene acrea saltmarsh caterpillar, Crambidae, Achyra rantalis garden webworm, Desmia funeralis grape leaffolder, Ostrinia nubilalis European corn borer, Gelechiidae, Anarsia lineatella peach twig borer, Keiferia lycopersicella tomato pinworm, Phthorimaea operculella potato tuberworm, Tuta absoluta S. American tomato pinworm, Geometridae, Operophthera brumata winter moth, Gracilaridae, Phyllocnistis citrella citrus leafminer, Lithocolletis ringoniella apple leafminer, Phyllonorycter blancardella spotted tentiform leafminer, Lyonetidae, Leucoptera spp. (ie: malifoliella, coffeella) coffee leafminer, pear leaf blister moth, Noctuidae, Agrotis ipsilon black cutworm, Alabama argillacea cotton leafworm, Amphipyra pyramidoides humped green fruitworm, Anticarsia gemmatalis velvetbean caterpillar, Autographa gamma common silver Y moth, Barathra brassicae cabbage armyworm, Earias spp. (ie: huegeliana, insulana, vitella) rough, spiny, northern rough bollworm, Helicoverpa spp. (ie: armigera, punctigera, zea) bollworms/budworms/fruitworms, Heliothis virescens tobacco budworm, Lithophane antennata green fruitworm, Mamestra brassicae cabbage moth, Orthosia hibisci green fruitworm, Phalaenoides glycinae grape vine moth, Phytometra acuta tomato semi-looper, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieridae, Pieris spp. (ie: brassica, rapae) large white, imported cabbageworm, Plutellidae, Plutella xylostella diamondback moth, Pyralidae, Amyelois transitella navel orangeworm, Chilo spp. (ie: infuscatellus, polychrysus, suppressalis) sugarcane/rice stem borers, Cnaphalocrocis medinalis rice leafroller, Crambus spp. sod webworm, Crocidolomia binotalis cabbage cluster caterpillar, Diaphania spp. (ie: hyalinata, nitidalis) melonworm, pickleworm, Diatraea saccharalis, Brazilian sugarcane borer, Elasmopalpus lignosellus lesser stalk borer, Evergestis rimosalis cross-stripped cabbageworm, Hedylepta indicata soybean leaffolder, Hellula spp. (ie: hydralis, undalis) cabbage centre-grub, cabbage webworm, Leucinodes orbonalis eggplant shoot and fruit borer, Maruca spp. pod borer, Neoleucinodes elegantalis tomato small borer, Scirpophaga spp. sugarcane/rice stem borer, Sesamia spp. (ie: inferens, nonagrioides) pink stem borer/corn stalk borer, Sphingidae, Manduca spp. (ie: quinquemaculata, sexta) tomato/tobacco hornworm, Tortricidae, Adoxophyes orana summer fruit tortrix, Argyrotaenia spp. (ie: pulchellana, velutinana) grape tortrix, redbanded leafroller, Bonagota cranaodes Brazilian apple leafroller, Carposina spp. (ie: niponensis, sasaki) peach fruit borer, peach fruit moth, Choristoneura rosaceana obliquebanded leafroller, Cryptophlebia leucotreta false codling moth, Cydia pomonella codling moth, Ecdytolopha aurantiana citrus borer, Endopiza vitana grape berry moth, Epiphyas postvittana light brown apple moth, Eupoecilia ambiguella European grape berry moth, Grapholita molesta oriental fruit moth, Lobesia botrana European grapevine moth, Pandemis spp. (ie: cerasana, heparana, barred fruit tree tortrix, limitata, pyrusana) apple brown tortrix, three-lined leafroller, apple pandemic, Platynota spp. (ie: idaeusalis, stultana) tufted apple bud moth, omnivorous leafroller, Zygaenidae, and Harrisina spp. (ie: americana, brillians) grapeleaf/western grapeleaf skeletonizer).

In some chlorantraniliprole aspects of the disclosure, the compositions of the disclosure are effective against: Leptinotarsa decemlineata Colorado potato beetle, Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Phthorimaea operculella potato tuberworm, Tuta absoluta S. American tomato pinworm, Phyllocnistis citrella citrus leafminer, Phyllonorycter blancardella spotted tentiform leafminer, Leucoptera spp. (ie: malifoliella, coffeella) coffee leafminer, Agrotis ipsilon black cutworm, Alabama argillacea cotton leafworm, Anticarsia gemmatalis velvetbean caterpillar, Helicoverpa spp. (ie: armigera, punctigera, zea) bollworms/budworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieris spp. (ie: brassica, rapae) large white, imported cabbageworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer, Leucinodes orbonalis eggplant shoot and fruit borer, Scirpophaga spp. sugarcane/rice stem borer, Sesamia spp. (ie: inferens, nonagrioides) pink stem borer/corn stalk borer, Carposina spp. (ie: niponensis, sasaki) peach fruit borer, peach fruit moth, Choristoneura rosaceana obliquebanded leafroller, Cydia pomonella codling moth, Eupoecilia ambiguella European grape berry moth, Grapholita molesta oriental fruit moth, and Lobesia botrana European grapevine moth.

In some chlorantraniliprole aspects of the disclosure, the compositions of the disclosure are effective against: Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Tuta absoluta S. American tomato pinworm, Anticarsia gemmatalis velvetbean caterpillar, Helicoverpa spp. (ie: armigera, punctigera, zea) bollworms/budworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer, Scirpophaga spp. sugarcane/rice stem borer, Sesamia spp. (ie: inferens, nonagrioides) pink stem borer/corn stalk borer, Cydia pomonella codling moth, Grapholita molesta oriental fruit moth, and Lobesia botrana European grapevine moth.

The term “agronomic” refers to the production of field crops such as for food and fiber and includes the growth of maize or corn, soybeans and other legumes, rice, cereal (e.g., wheat, oats, barley, rye and rice), leafy vegetables (e.g., lettuce, cabbage, and other cole crops), fruiting vegetables (e.g., tomatoes, pepper, eggplant, crucifers and cucurbits), potatoes, sweet potatoes, grapes, cotton, tree fruits (e.g., pome, stone and citrus), small fruit (e.g., berries and cherries) and other specialty crops (e.g., canola, sunflower and olives).

These present compositions are thus useful for protecting agronomic field crops other non-agronomic horticultural crops and plants from invertebrate pests. This utility includes protecting crops and other plants (i.e. both agronomic and nonagronomic) that contain genetic material introduced by genetic engineering (i.e. transgenic) or modified by mutagenesis to provide advantageous traits. Examples of such traits include tolerance to herbicides, resistance to invertebrate pests (e.g., insects, mites, aphids, spiders, nematodes, snails, plant-pathogenic fungi, bacteria and viruses), improved plant growth, increased tolerance of adverse growing conditions such as high or low temperatures, low or high soil moisture, and high salinity, increased flowering or fruiting, greater harvest yields, more rapid maturation, higher quality and/or nutritional value of the harvested product, or improved storage or process properties of the harvested products. Transgenic plants can be modified to express multiple traits.

Examples of plants containing traits provided by genetic engineering or mutagenesis include varieties of corn, cotton, soybean and potato expressing an insecticidal Bacillus thuringiensis toxin such as YIELD GARD®, KnockOut®, StarLink®, Bollgard®, NuCOTN® and NewLeaf®, INVICTA RR2 PRO™, and herbicide-tolerant varieties of corn, cotton, soybean and rapeseed such as Roundup Ready®, Liberty Link®, IMI®, STS® and Clearfield®, as well as crops expressing N-acetyltransferase (GAT) to provide resistance to glyphosate herbicide, or crops containing the HRA gene providing resistance to herbicides inhibiting acetolactate synthase (ALS). The present compositions may interact synergistically with traits introduced by genetic engineering or modified by mutagenesis, thus enhancing phenotypic expression or effectiveness of the traits or increasing the invertebrate pest control effectiveness of the present compounds and compositions. In particular, the present compositions may interact synergistically with the phenotypic expression of proteins or other natural products toxic to invertebrate pests to provide greater-than-additive control of these pests, i.e. produce a combined effect greater than the sum of their separate effects.

Plants within the scope of the present disclosure include crops, vegetables, fruits, trees other than fruit trees, lawn, and other uses (flowers, biofuel plants and ornamental foliage). Crops include corn, rice, wheat, barley, rye, oat, sorghum, cotton, soybean, peanut, buckwheat, beet, rapeseed, sunflower, sugar cane, tobacco, and others known in the art. Vegetables include: solanaceous vegetables (for example, eggplant, tomato, pimento, pepper and potato); cucurbitaceous vegetables (for example, cucumber, pumpkin, zucchini, water melon, and melon); cruciferous vegetables (for example, Japanese radish, white turnip, horseradish, kohlrabi, Chinese cabbage, cabbage, leaf mustard, broccoli, and cauliflower); asteraceous vegetables (for example, burdock, crown daisy, artichoke and lettuce); liliaceous vegetables (for example, green onion, onion, garlic and asparagus); ammiaceous vegetables (for example, carrot, parsley, celery and parsnip); chenopodiaceous vegetables (for example, spinach and Swiss chard); and lamiaceous vegetables (for example, Perilla frutescens, mint and basil). Fruits include: pomaceous fruits (for example, apple, pear, Japanese pear, Chinese quince and quince); stone fleshy fruits (for example, peach, plum, nectarine, Prunus mume, cherry fruit, apricot and prune); citrus fruits (for example, Citrus unshiu, orange, lemon, lime and grapefruit); nuts (for example, chestnut, walnuts, hazelnuts, almond, pecan, pistachio, cashew nuts and macadamia nuts); berry fruits (for example, blueberry, cranberry, blackberry, strawberry, and raspberry); grape; kaki; persimmon; olive; Japanese plum; banana; coffee; date palm; coconuts; and oil palm. Trees other than fruit trees include: tea; mulberry; and other trees (for example, ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, Taxus cuspidate, elm and Japanese horse chestnut), Sweet viburnum, Podocarpus macrophyllus, Japanese cedar, Japanese cypress, croton, Japanese spindletree, and Photinia glabra). Lawn uses include sods (for example, Zoysia japonica, Zoysia matrella); bermudagrasses; bent grasses; festucae; ryegrasses. Flower uses include: rose, carnation, chrysanthemum, Eustoma, gypsophila, gerbera, marigold, salvia, petunia, verbena, tulip, aster, gentian, lily, pansy, cyclamen, orchid, lily of the valley, lavender, stock, ornamental cabbage, primula, poinsettia, gladiolus, cattleya, daisy, cymbidium and begonia. Bio-fuel plants include: jatropha, safflower, Camelina, switch grass, Miscanthus giganteus, Phalaris arundinacea, Arundo donax, kenaf, cassava, and willow.

All plants or any part of a plant can be treated in accordance with the disclosure. The term “plants” as used herein is to be understood as all plants and plant populations such as, for example, desired and undesired wild plants or crop plants (including naturally occurring crop plants). Crop plants can be plants that can be obtained by conventional breeding and optimization methods or by biotechnological and genetic engineering methods or by combinations of these methods, including transgenic plants and including plant cultivars which can or cannot be protected by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits and seeds, as well as roots, tubers and rhizomes. The plant parts also include harvested material, and vegetative and generative propagation material, for example cuttings, tubers, rhizomes, offshoots and seeds.

Wild plant species and plant cultivars, or those obtained by conventional biological breeding methods, such as crossing or protoplast fusion, and parts thereof, may be treated. Also, transgenic plants and plant cultivars obtained by genetic engineering methods, if appropriate in combination with conventional methods (Genetically Modified Organisms), and parts thereof are treated. Plants of the plant cultivars that are in each case commercially available or in use are treated according to the disclosure. Plant cultivars are to be understood as meaning plants having novel properties (“traits”) which have been obtained by conventional breeding, by mutagenesis or by recombinant DNA techniques. These can be cultivars, biotypes or genotypes.

The transgenic plants or plant cultivars (obtained by genetic engineering) that may be treated according to the disclosure include all plants which, by the genetic modification, received genetic material which imparted particular advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products. Further and particularly emphasized examples of such traits are a better defense of the plants against animal and microbial pests, such as against insects, mites, phytopathogenic fungi, bacteria and/or viruses, and increased tolerance of the plants to certain herbicidally active compounds. Examples of transgenic plants include the important crop plants, such as cereals (wheat, rice), maize, soybeans, potatoes, sugar beet, tomatoes, peas and other vegetable varieties, cotton, tobacco, oilseed rape and fruit plants (with the fruits apples, pears, citrus fruits and grapes), and emphasis is given to maize, soybeans, potatoes, cotton, tobacco and oilseed rape. Traits include the increased defense of the plants against insects, arachnids, nematodes and slugs and snails by toxins formed in the plants, particularly those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (“Bt plants”). Other traits are the increased defense of plants against fungi, bacteria and viruses by systemic acquired resistance (SAR), systemin, phytoalexins, elicitors and resistance genes and correspondingly expressed proteins and toxins. Traits also include the increased tolerance of the plants to certain herbicidally active compounds, for example imidazolinones, sulfonylureas, glyphosate or phosphinotricin (for example the “PAT” gene). The genes which impart the desired traits in question can also be present in combinations with one another in the transgenic plants. Examples of “Bt plants” include maize varieties, cotton varieties, soybean varieties and potato varieties which are sold under the trade names YIELD GARD® (for example maize, cotton, soybeans), KnockOut® (for example maize), StarLink® (for example maize), Bollgard® (cotton), Nucotn® (cotton) and NewLeaf® (potato). Examples of herbicide-tolerant plants are maize varieties, cotton varieties and soybean varieties that are sold under the trade names Roundup Ready® (tolerance to glyphosate, for example maize, cotton, soybean). Liberty Link® (tolerance to phosphinotricin, for example oilseed rape), IMI® (tolerance to imidazolinones) and STS® (tolerance to sulfonylureas, for example maize). Herbicide-resistant plants (plants bred in a conventional manner for herbicide tolerance) include the varieties sold under the name Clearfield® (for example maize). The agricultural crops are selected from the group consisting of cereals, fruit trees, citrus fruits, legumes, horticultural crops, cucurbits, oleaginous plants, tobacco, coffee, tea, cocoa, sugar beet, sugar cane, and cotton.

Depending on the plant species or plant cultivars, their location and growth conditions (soils, climate, vegetation period, diet), the treatment according to the disclosure may also result in superadditive (“synergistic”) effects. Thus, for example, reduced application rates and/or a widening of the activity spectrum and/or an increase in the activity of the substances and compositions which can be used according to the disclosure, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

Crops that can be protected with the compositions according to this disclosure, for example, comprise cereals (wheat, barley, rye, oats, rice, maize, sorghum, etc.), fruit trees (apples, pears, plums, peaches, almonds, cherries, bananas, grapes, strawberries, raspberries, blackberries, etc.), citrus trees (oranges, lemons, mandarins, grapefruit, etc.), legumes (beans, peas, lentils, soybean, etc.), vegetables (spinach, lettuce, asparagus, cabbage, carrots, onions, tomatoes, potatoes, eggplants, peppers, etc.), cucurbitaceae (pumpkins, zucchini, cucumbers, melons, watermelons, etc.), oleaginous plants (sunflower, rape, peanut, castor, coconut, etc.), tobacco, coffee, tea, cocoa, sugar beet, sugar cane, and cotton.

Non-agronomic uses refer to invertebrate pest control in the areas other than fields of crop plants. Nonagronomic uses of the present compositions include control of invertebrate pests in stored grains, beans and other foodstuffs, and in textiles such as clothing and carpets. Nonagronomic uses of the present compositions also include invertebrate pest control in ornamental plants, forests, in yards, along roadsides and railroad rights of way, and on turf such as lawns, golf courses and pastures. Nonagronomic uses of the present compositions also include invertebrate pest control in houses and other buildings which may be occupied by humans and/or companion, farm, ranch, zoo or other animals. Nonagronomic uses of the present compositions also include the control of pests such as termites that can damage wood or other structural materials used in buildings.

Nonagronomic uses of the present compositions also include protecting human and animal health by controlling invertebrate pests that are parasitic or transmit infectious diseases. The protection of an animal from an invertebrate parasitic pest includes administering a parasiticidally effective (i.e. biologically effective) amount of a composition of the disclosure, typically in the form of a composition formulated for veterinary use, to the animal to be protected. The controlling of animal parasites includes controlling external parasites that are parasitic to the surface of the body of the host animal (e.g., shoulders, armpits, abdomen, inner part of the thighs) and internal parasites that are parasitic to the inside of the body of the host animal (e.g., stomach, intestine, lung, veins, under the skin, lymphatic tissue). External parasitic or disease transmitting pests include, for example, chiggers, ticks, lice, mosquitoes, flies, mites and fleas. Internal parasites include heartworms, hookworms and helminths. Compositions of the present disclosure are particularly suitable for combating external parasitic or disease transmitting pests. Compositions of the present disclosure are suitable for combating parasites that infest agricultural working animals, such as cattle, sheep, goats, horses, pigs, donkeys, camels, buffalos, rabbits, hens, turkeys, ducks, geese and bees; pet animals and domestic animals such as dogs, cats, pet birds and aquarium fish; as well as so-called experimental animals, such as hamsters, guinea pigs, rats and mice. As referred to in the present disclosure and claims, the terms “parasiticidal” and “parasiticidally” refers to observable effects on an invertebrate parasite pest to provide protection of an animal from the pest. Parasiticidal effects typically relate to diminishing the occurrence or activity of the target invertebrate parasitic pest. Such effects on the pest include necrosis, death, retarded growth, diminished mobility or lessened ability to remain on or in the host animal, reduced feeding and inhibition of reproduction. These effects on invertebrate parasite pests provide control (including prevention, reduction or elimination) of parasitic infestation or infection of the animal. By combating these parasites, fatalities and performance reduction (in terms of meat, milk, wool, skins, eggs, honey, etc.) are reduced, so that applying a composition of the present disclosure allows more economic and simple husbandry of animals.

Embodiments of the disclosure include a bait composition for controlling an invertebrate pest comprising a biologically effective amount of a composition of the disclosure, one or more food materials, optionally an attractant, and optionally a humectant. Embodiments of the disclosure also include a device for controlling an invertebrate pest comprising said bait composition and a housing adapted to receive said bait composition, wherein the housing has at least one opening sized to permit the invertebrate pest to pass through the opening so the invertebrate pest can gain access to said bait composition from a location outside the housing, and wherein the housing is further adapted to be placed in or near a locus of potential or known activity for the invertebrate pest.

Embodiments of the disclosure also include methods for protecting a seed from an invertebrate pest comprising contacting the seed with a biologically effective amount of the composition of any of the Embodiments disclosed herein.

Embodiments of the disclosure also include methods for protecting an animal from an invertebrate parasitic pest comprising administering to the animal a parasiticidally effective amount of the composition of any of the Embodiments disclosed herein.

Embodiments of the disclosure also include methods for controlling an invertebrate pest comprising contacting the invertebrate pest or its environment with a biologically effective amount of the composition of any of the Embodiments disclosed herein, provided that the methods are not methods of medical treatment of a human or animal body by therapy.

This disclosure also provides a method for protecting a seed from an invertebrate pest comprising contacting the seed with a biologically effective amount of the composition of any of the Embodiments disclosed herein. This disclosure also relates to the treated seed (i.e. seed contacted with the composition of any of the Embodiments disclosed herein).

This disclosure also provides a method for increasing vigor of a crop plant comprising contacting the crop plant, the seed from which the crop plant is grown or the locus (e.g., growth medium) of the crop plant with a biologically effective amount of the composition of any of the Embodiments disclosed herein.

This disclosure further provides a method for protecting an animal from an invertebrate parasitic pest comprising administering to the animal a parasiticidally effective amount of the composition of any of the Embodiments disclosed herein. This disclosure also provides for the use of the composition of any of the Embodiments disclosed herein in protecting an animal from an invertebrate pest.

Embodiments of this disclosure also include use of an unmanned aerial vehicle (UAV) for the dispersion of the compositions disclosed herein over a planted area. In some embodiments the planted area is a crop-containing area. In some embodiments, the crop is selected from a monocot or dicot. In some embodiments, the crop is selected form rice, corn, barley, soybean, wheat, vegetable, tobacco, tea tree, fruit tree and sugar cane.

In some aspects of the disclosure, a method of controlling invertebrate pests on plants is provided. The method comprises applying a composition recited herein to a plurality of the plants, wherein the composition is applied to the plants via an unmanned aerial vehicle (“UAV”) at a rate sufficient to achieve a total amount of applied diamide insecticide of from about 10 grams per hectare to about 500 grams per hectare, and wherein the mortality of a plurality of the sucking pests is at least 75% evaluated at three days after exposure to the active ingredient. As used herein, UAV refers generally to any unmanned or remotely piloted vehicle or system.

Embodiments of the present disclosure as described in the Summary include those described below.
Embodiment 1. The composition described in the Summary wherein the weight ratio of bifenthrin to diamide insecticide on an active ingredient basis is from about 5:1 to about 1:5.
Embodiment 2. The composition described in the Summary wherein the weight ratio of bifenthrin to diamide insecticide on an active ingredient basis is from about 5:1 to about 1:1.
Embodiment 3. The composition described in the Summary or Embodiment 1 wherein the weight ratio of bifenthrin to diamide insecticide on an active ingredient basis is between about 3:1 and about 1:1.
Embodiment 4. The composition described in the Summary or Embodiment 1 wherein the weight ratio of bifenthrin to diamide insecticide on an active ingredient basis is between about 2.1:1 and about 1.1:1.
Embodiment 5. The composition described in the Summary or any of the preceding Embodiments wherein the weight ratio of bifenthrin to diamide insecticide on an active ingredient basis is about 1.6:1.
Embodiment 6. The composition described in the Summary or any of the preceding Embodiments wherein the diamide insecticide concentration is from about 0.01 wt. % to about 5.0 wt. % of the total weight of the composition.
Embodiment 7. The composition described in the Summary or any of the preceding Embodiments wherein the diamide insecticide concentration is from about 0.01 wt. % to about 2.0 wt. % of the total weight of the composition.
Embodiment 8. The composition described in the Summary or any of the preceding Embodiments wherein the diamide insecticide concentration is from about 0.10 wt. % to about 0.50 wt. % of the total weight of the composition.
Embodiment 9. The composition described in the Summary or any of the preceding Embodiments wherein the diamide insecticide concentration is from about 0.19 wt. % to about 0.31 wt. % of the total weight of the composition.
Embodiment 10. The composition described in the Summary or any of the preceding Embodiments wherein the diamide insecticide concentration is about 0.25 wt. % of the total weight of the composition.
Embodiment 11. The composition described in the Summary or any of the preceding Embodiments wherein the bifenthrin concentration is from about 0.02 wt. % to about 8.0 wt. % of the total weight of the composition.
Embodiment 12. The composition described in the Summary or any of the preceding Embodiments wherein the bifenthrin concentration is from about 0.02 wt. % to about 3.2 wt. % of the total weight of the composition.
Embodiment 13. The composition described in the Summary or any of the preceding Embodiments wherein the bifenthrin concentration is from about 0.16 wt. % to about 0.80 wt. % of the total weight of the composition.
Embodiment 14. The composition described in the Summary or any of the preceding Embodiments wherein the bifenthrin concentration is from about 0.30 wt. % to about 0.50 wt. % of the total weight of the composition.
Embodiment 15. The composition described in the Summary or any of the preceding Embodiments wherein the bifenthrin concentration is about 0.40 wt. % of the total weight of the composition.
Embodiment 16. The composition described in the Summary or any of the preceding Embodiments wherein the diamide insecticide is a diamide insecticide as described in U.S. Pat. No. 6,747,047.
Embodiment 16A. The composition described in the Summary or any of the preceding Embodiments wherein the diamide insecticide is a diamide insecticide as described in U.S. Pat. No. 7,232,836.
Embodiment 16B. The composition described in the Summary or any of the preceding Embodiments wherein the diamide insecticide is a diamide insecticide as described in U.S. Pat. No. 7,247,647.
Embodiment 16C. The composition described in the Summary or any of the preceding Embodiments wherein the diamide insecticide is selected from chlorantraniliprole, cyantraniliprole, tetrachlorantraniliprole, bromoantraniliprole, dichlorantraniliprole, tetraniliprole, cyclaniliprole, cyhalodiamide and flubendiamide.
Embodiment 17. The composition of Embodiment 16 wherein the diamide insecticide is selected from chlorantraniliprole or cyantraniliprole.
Embodiment 18. The composition of Embodiment 17 wherein the diamide insecticide is chlorantraniliprole.
Embodiment 19. The composition of Embodiment 17 wherein the diamide insecticide is cyantraniliprole.
Embodiment 20. The composition of any of the preceding Embodiments, wherein the composition further comprises an additional pesticidal active ingredient selected from abamectin, acephate, acequinocyl, acetamiprid, acrinathrin, acynonapyr, afidopyropen ([(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11H-naphtho[2,1-b]pyrano[3,4-e]pyran-4-yl]methyl cyclopropanecarboxylate), amidoflumet, amitraz, avermectin, azadirachtin, azinphos methyl, benfuracarb, bensultap, benzpyrimoxan, bifenthrin, kappa-bifenthrin, bifenazate, bistrifluron, borate, broflanilide, buprofezin, cadusafos, carbaryl, carbofuran, cartap, carzol, chlorantraniliprole, chlorfenapyr, chlorfluazuron, chloroprallethrin, chlorpyrifos, chlorpyrifos-e, chlorpyrifos-methyl, chromafenozide, clofentezin, chloroprallethrin, clothianidin, cyantraniliprole, (3-bromo-1-(3-chloro-2-pyridinyl)-N-[4-cyano-2-methyl-6-[(methylamino) carbonyl]phenyl]-1H-pyrazole-5-carboxamide), cyclaniliprole (3-bromo-N-[2-bromo-4-chloro-6-[[(1-cyclopropylethyl) amino]carbonyl]phenyl]-1-(3-chloro-2-pyridinyl)-1H-pyrazole-5-carboxamide), cycloprothrin, cycloxaprid ((5S,8R)-1-[(6-chloro-3-pyridinyl)methyl]-2,3,5,6,7,8-hexahydro-9-nitro-5,8-epoxy-1H-imidazo[1,2-a]azepine), cyenopyrafen, cyflumetofen, cyfluthrin, beta cyfluthrin, cyhalodiamide, cyhalothrin, gamma-cyhalothrin, lambda-cyhalothrin, cypermethrin, alpha-cypermethrin, zeta-cypermethrin, cyromazine, deltamethrin, diafenthiuron, diazinon, dicloromezotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(trifluoromethoxy) phenoxy]-4-quinolinyl methyl carbonate), flonicamid, fluazaindolizine, flubendiamide, flucythrinate, flufenerim, flufenoxuron, flufenoxystrobin (methyl (αE)-2-[2-chloro-4-(trifluoromethyl) phenoxy]methyl]-α-(methoxymethylene)benzeneacetate), fluensulfone (5-chloro-2-[(3,4,4-trifluoro-3-buten-1-yl) sulfonyl]thiazole), fluhexafon, fluopyram, flupiprole (1-[2,6-dichloro-4-(trifluoromethyl)phenyl]-5-[(2-methyl-2-propen-1-yl)amino]-4-[(trifluoromethyl) sulfinyl]-1H-pyrazole-3-carbonitrile), flupyradifurone (4-[[(6-chloro-3-pyridinyl)methyl](2,2-difluoroethyl)amino]-2 (5H)-furanone), flupyrimin, fluvalinate, tau fluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin ([2,3,5,6-tetrafluoro-4-(methoxymethyl)phenyl]methyl (1R,3S)-3-(2,2-dichloroethenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethylcyclopropanecarboxylate), nicotine, nitenpyram, nithiazine, novaluron, noviflumuron, N-[1,1-dimethyl-2-(methylthio)ethyl]-7-fluoro-2-(3-pyridinyl)-2H-indazole-4-carboxamide, N-[1,1-dimethyl-2-(methylsulfinyl)ethyl]-7-fluoro-2-(3-pyridinyl)-2H-indazole-4-carboxamide, N-[1,1-dimethyl-2-(methylsulfonyl)ethyl]-7-fluoro-2-(3-pyridinyl)-2H-indazole-4-carboxamide, N-(1-methylcyclopropyl)-2-(3-pyridinyl)-2H-indazole-4-carboxamide, and N-[1-(difluoromethyl)cyclopropyl]-2-(3-pyridinyl)-2H-indazole-4-carboxamide, oxamyl, oxazosulfyl, parathion, parathion methyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin, pyridaben, pyridalyl, pyrifluquinazon, pyriminostrobin (methyl (αE)-2-[[[2-[(2,4-dichlorophenyl)amino]-6-(trifluoromethyl)-4-pyrimidinyl]oxy]methyl]-α-(methoxymethylene)benzeneacetate), pydiflumetofen, pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-λ⁴-sulfanylidene]cyanamide), tebufenozide, tebufenpyrad, teflubenzuron, tefluthrin, kappa-tefluthrin, terbufos, tetrachlorantraniliprole, tetrachlorvinphos, tetramethrin, tetramethylfluthrin ([2,3,5,6-tetrafluoro-4-(methoxymethyl)phenyl]methyl 2,2,3,3-tetramethylcyclopropanecarboxylate), tetraniliprole, thiacloprid, thiamethoxam, thiodicarb, thiosultap-sodium, tioxazafen (3-phenyl-5-(2-thienyl)-1,2,4-oxadiazole), tolfenpyrad, tralomethrin, triazamate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuron, tyclopyrazoflor, zeta-cypermethrin, Bacillus thuringiensis delta-endotoxins, entomopathogenic bacteria, entomopathogenic viruses, entomopathogenic fungi, and combinations thereof.
Embodiment 21. The composition described in the Summary or any of the preceding Embodiments wherein at least one additional adjuvant is selected from the group consisting of drying agents, thickening agents, wetting agents, solvents, sticking agents, dispersants, solid carriers, and combinations of any of the foregoing.
Embodiment 22. The composition of Embodiment 21 wherein at least one additional adjuvant is a drying agent.
Embodiment 22A. The composition of Embodiment 22 wherein the drying agent is present at a concentration from about 0.01 wt. % to about 5.0 wt. % of the total weight of the composition.
Embodiment 22B. The composition of Embodiment 22 wherein the drying agent is present at a concentration from about 0.01 wt. % to about 1.0 wt. % of the total weight of the composition.
Embodiment 22C. The composition of Embodiment 22 wherein the drying agent is present at a concentration from about 0.05 wt. % to about 0.35 wt. % of the total weight of the composition.
Embodiment 22D. The composition of Embodiment 22 wherein the drying agent is present at a concentration from about 0.10 wt. % to about 0.30 wt. % of the total weight of the composition.
Embodiment 23. The composition of Embodiment 22 wherein at least one drying agent is selected from the group consisting of calcium silicate, calcium carbonate, talc, kaolin, bentonite, diatomaceous earth, fumed silica, precipitated silica, colloidal silica, amorphous silica, sodium aluminosilicate, microcrystalline cellulose, attapulgite clay, and combinations of any of the foregoing.
Embodiment 24. The composition of Embodiment 23 wherein the drying agent is selected from the group of precipitated silicas, fumed silicas, amorphous silicas and diatomaceous earth.
Embodiment 25. The composition of Embodiment 24 wherein the drying agent is a precipitated synthetic amorphous silica.
Embodiment 26. The composition of Embodiment 21 wherein at least one additional adjuvant is a solvent.
Embodiment 26A. The composition of Embodiment 26 wherein the solvent is present at a concentration from about 0.01 wt. % to about 5.0 wt. % of the total weight of the composition.
Embodiment 26B. The composition of Embodiment 26 wherein the solvent is present at a concentration from about 0.10 wt. % to about 1.0 wt. % of the total weight of the composition.
Embodiment 26C. The composition of Embodiment 26 wherein the solvent is present at a concentration from about 0.15 wt. % to about 0.50 wt. % of the total weight of the composition.
Embodiment 26D. The composition of Embodiment 26 wherein the solvent is present at a concentration from about 0.20 wt. % to about 0.40 wt. % of the total weight of the composition.
Embodiment 27. The composition of Embodiment 26 wherein the solvent is capable of dissolving bifenthrin.
Embodiment 27A. The composition of Embodiment 26 wherein the solvent wherein the solvent is selected from the group consisting of alcohols, alkanes, alkenes, alkynes, phenols, hydrocarbons, chlorinated hydrocarbons, aromatic hydrocarbons, ketones, water and ethers.
Embodiment 27B. The composition of Embodiment 26 wherein the solvent is selected from the group consisting of hydrotreated light petroleum distillates and hydrotreated medium petroleum distillates.
Embodiment 28. The composition of Embodiment 27 wherein the solvent is a hydrotreated light petroleum distillate.
Embodiment 29. The composition of Embodiment 21 wherein at least one additional adjuvant is a sticking agent.
Embodiment 29A. The composition of Embodiment 29 wherein the sticking agent is present at a concentration from about 0.01 wt. % to about 5.0 wt. % of the total weight of the composition.
Embodiment 29B. The composition of Embodiment 29 wherein the sticking agent is present at a concentration from about 0.01 wt. % to about 1.0 wt. % of the total weight of the composition.
Embodiment 29C. The composition of Embodiment 29 wherein the sticking agent is present at a concentration from about 0.05 wt. % to about 0.25 wt. % of the total weight of the composition.
Embodiment 29D. The composition of Embodiment 29 wherein the sticking agent is present at a concentration from about 0.10 wt. % to about 0.20 wt. % of the total weight of the composition.
Embodiment 30. The composition of Embodiment 29 wherein the sticking agent is selected from the group consisting polyvinyl alcohols, polyvinyl acetates, acrylic acids, polyacrylic acid, polyvinyl pyrrolidone, polyethylene oxide, copolymers of acrylic acid, salts thereof, and combinations of any of the foregoing.
Embodiment 30a. The composition of Embodiment 29 wherein the sticking agent is selected from the group consisting polyvinyl alcohols, polyvinyl acetates, acrylic acids, polyacrylic acid, copolymers of acrylic acid, salts thereof, and combinations of any of the foregoing.
Embodiment 31. The composition of Embodiment 30 wherein the sticking agent is a polyacrylic acid.
Embodiment 32. The composition of Embodiment 21 wherein at least one additional adjuvant is a solid carrier.
Embodiment 32A. The composition of Embodiment 32 wherein the solid carrier is present at a concentration of at least about 80.0 wt. % of the total weight of the composition.
Embodiment 32B. The composition of Embodiment 32 wherein the solid carrier is present at a concentration of at least about 90.0 wt. % of the total weight of the composition.
Embodiment 32C. The composition of Embodiment 32 wherein the solid carrier is present at a concentration of at least about 95.0 wt. % of the total weight of the composition.
Embodiment 32D. The composition of Embodiment 32 wherein the solid carrier is present at a concentration of at least about 97.0 wt. % of the total weight of the composition.
Embodiment 33. The composition Embodiment 32 wherein the solid carrier is selected from the group consisting of wood flours, clays, activated carbon, diatomaceous earth, fine-grain inorganic solids and carbonate minerals.
Embodiment 34. The composition of Embodiment 33 wherein the solid carrier is an anhydrous carbonate mineral.
Embodiment 35. The composition described in the Summary or any of the preceding Embodiments wherein the composition is a dust, powder, granule, pellet, prill, pastille or tablet.
Embodiment 36. The composition of Embodiment 35 wherein the composition is a dust, powder, granule, pellet or prill.
Embodiment 37. The composition of Embodiment 35 wherein the composition is a granule, pellet, prill, pastille or tablet.
Embodiment 38. The composition of Embodiments 36 or 37 wherein the composition is a dust.
Embodiment 39. The composition described in the Summary or any of Embodiments 1-37 wherein the composition is a powder, granule, pellet or prill.
Embodiment 40. The composition of Embodiment 39 wherein the composition is a powder.
Embodiment 41. The composition of Embodiment 39 wherein the composition is a granule, pellet or prill.
Embodiment 42. The composition of Embodiment 41 wherein the composition is a granule.
Embodiment 43. The composition of Embodiment 41 wherein the composition is a pellet.
Embodiment 44. The composition of Embodiment 41 wherein the composition is a prill.
Embodiment 45. The composition of Embodiment 35 wherein the composition is a pastille or tablet.
Embodiment 46. The composition of Embodiment 37 wherein the composition is a pastille.
Embodiment 47. The composition of Embodiment 37 wherein the composition is a tablet.
Embodiment 48. The composition of Embodiment 37 wherein the composition disintegrates.
Embodiment 49. The composition of the Summary or any of the preceding Embodiments wherein the solid pesticidal composition comprises particles of a solid carrier infiltrated with a mixture of bifenthrin and a diamide insecticide.
Embodiment 50. The composition of the Summary or any of the preceding Embodiments wherein the solid pesticidal composition comprises particles of a solid carrier infiltrated with a mixture of bifenthrin, a diamide insecticide and at least one additional adjuvant.
Embodiment M1. A process for preparing the composition described in the Summary or any of the preceding Embodiments, said process comprising
   a) forming a first mixture of Bifenthrin, a first solvent and a solid carrier;
   b) adding a sticking agent to the mixture of step a);
   c) adding a diamide insecticide to the mixture of step b); and
   d) adding a drying agent to the mixture of step c).
Embodiment M1A. The process of Embodiment M1 wherein the sticking agent is present at a concentration from about 0.01 wt. % to about 5.0 wt. % of the total weight of the composition.
Embodiment M1B. The process of Embodiment M1 wherein the sticking agent is present at a concentration from about 0.01 wt. % to about 1.0 wt. % of the total weight of the composition.
Embodiment M1C. The process of Embodiment M1 wherein the sticking agent is present at a concentration from about 0.05 wt. % to about 0.25 wt. % of the total weight of the composition.
Embodiment M1D. The process of Embodiment M1 wherein the sticking agent is present at a concentration from about 0.10 wt. % to about 0.20 wt. % of the total weight of the composition.
Embodiment M1E. The process of Embodiment M1 wherein the sticking agent is selected from the group consisting polyvinyl alcohols, polyvinyl acetates, acrylic acids, polyacrylic acid, copolymers of acrylic acid and salts thereof.
Embodiment M1F. The process of Embodiment M1 wherein the sticking agent is selected from the group consisting polyvinyl alcohols, polyvinyl acetates, acrylic acids, polyacrylic acid, polyvinyl pyrrolidone, polyethylene oxide, copolymers of acrylic acid and salts thereof.
Embodiment M1G. The process of Embodiment M1 wherein the sticking agent is a polyacrylic acid.
Embodiment M2. The process of Embodiment M1, further comprising adding a second solvent to the sticking agent of step b) prior to adding the sticking agent to the mixture of step a).
Embodiment M3. The process of Embodiment M2, wherein the second solvent is water.
Embodiment M3A. The process of Embodiment M3 wherein the water is less than 10.0 wt. % the total weight of the composition.
Embodiment M3B. The process of Embodiment M3 wherein the water is less than 5.0 wt. % of the total weight of the composition.
Embodiment M3C. The process of Embodiment M3 wherein the water is less than 1.0 wt. % of the total weight of the composition.
Embodiment M3D. The process of Embodiment M3 wherein the water is less than 0.6 wt. % of the total weight of the composition.
Embodiment M3E. The process of Embodiment M3 wherein the water is about 0.06 wt. % of the total weight of the composition
Embodiment M4. A process for preparing the composition described in the Summary or any of the preceding Embodiments, said process comprising
   i) forming a first mixture of Bifenthrin, a solvent and a solid carrier;
   ii) forming a second mixture of a sticking agent, a diamide insecticide and, optionally, water;
   iii) adding the second mixture of step ii) to the first mixture of step i); and
   iv) adding a drying agent to the mixture of step iii).
Embodiment M4A. The process of Embodiment M4 wherein the sticking agent is present at a concentration from about 0.01 wt. % to about 5.0 wt. % of the total weight of the composition.
Embodiment M4B. The process of Embodiment M4 wherein the sticking agent is present at a concentration from about 0.01 wt. % to about 1.0 wt. % of the total weight of the composition.
Embodiment M4C. The process of Embodiment M4 wherein the sticking agent is present at a concentration from about 0.05 wt. % to about 0.25 wt. % of the total weight of the composition.
Embodiment M4D. The process of Embodiment M4 wherein the sticking agent is present at a concentration from about 0.10 wt. % to about 0.20 wt. % of the total weight of the composition.
Embodiment M4E. The process of Embodiment M4 wherein the sticking agent is selected from the group consisting polyvinyl alcohols, polyvinyl acetates, acrylic acids, polyacrylic acid, copolymers of acrylic acid and salts thereof.
Embodiment M4F. The process of Embodiment M4 wherein the sticking agent is selected from the group consisting polyvinyl alcohols, polyvinyl acetates, acrylic acids, polyacrylic acid, polyvinyl pyrrolidone, polyethylene oxide, copolymers of acrylic acid and salts thereof.
Embodiment M4G. The process of Embodiment M4 wherein the sticking agent is a polyacrylic acid.
Embodiment M5. The process of Embodiment M4, wherein the second solvent is water.
Embodiment M5A. The process of Embodiment M5 wherein the water is less than 10.0 wt. % the total weight of the composition.
Embodiment M5B. The process of Embodiment M5 wherein the water is less than 5.0 wt. % of the total weight of the composition.
Embodiment M5C. The process of Embodiment M5 wherein the water is less than 1.0 wt. % of the total weight of the composition.
Embodiment M5D. The process of Embodiment M5 wherein the water is less than 0.6 wt. % of the total weight of the composition.
Embodiment M5E. The process of Embodiment M5 wherein the water is about 0.06 wt. % of the total weight of the composition
Embodiment X. A solid pesticidal composition for protecting an organism from an invertebrate parasitic pest comprising parasiticidally effective amount of the composition described in the Summary or any of the preceding Embodiments.
Embodiment X1. The composition of Embodiment X wherein the organism is a plant.
Embodiment X2. The composition of Embodiment X wherein the organism is an animal.
Embodiment X3. The composition of Embodiment X2 wherein the composition is in a form for oral administration.
Embodiment Z. A method for controlling an invertebrate pest comprising contacting the invertebrate pest or its environment with a biologically effective amount of the composition described in the Summary or any of the preceding Embodiments.
Embodiment Z1. The method of Embodiment Z wherein the environment is a plant.
Embodiment Z2. The method of Embodiment Z wherein the environment is an animal.
Embodiment Z3. The method of Embodiment Z wherein the environment is a seed.

Embodiments of this disclosure can be combined in any manner.

Without further elaboration, it is believed that one skilled in the art using the preceding description can utilize the present disclosure to its fullest extent. The following Examples are, therefore, to be construed as merely illustrative, and not limiting of the disclosure in any way whatsoever.

### FORMULATION EXAMPLES

The identities and purposes of the ingredients named in the examples are briefly described Table A below.

TABLE A
Identity of Ingredients used in Examples

| Formulation | | |
|---|---|---|
| Ingredient | Category | Description |
| Bifenthrin (Youjia) | Insecticide | (2-Methyl-[1,1′-biphenyl]-3-yl)methyl 3-(2-chloro-3,3,3-trifluoro- |
| | | 1-propenyl)-2,2-dimethylcyclopropanecarboxylate (CAS # |
| | | 82657-04-3) |
| Chlorantraniliprole | Insecticide | 3-Bromo-N-(4-chloro-2-methyl-6-((methylamino)carbonyl)- |
| (FMC Corp.) | | phenyl)-1-(3-chloro-2-pyridinyl)-1H-pyrazole-5-carboxamide |
| | | (CAS # 500008-45-7) |
| AGROCER ® | colorant | Polychloro copper phthalocyanine (CAS # 1328-53-6) |
| GREEN 007 | | |
| (Clariant) | | |
| TIXOSIL ® 38AB | drying agent | Precipitated synthetic amorphous silica (CAS # 112926-00-8) |
| (Solvay) | | |
| SOKALAN ® PA 25 | sticking agent | Polyacrylic acid, partially neutralized sodium salt |
| CL PN (BASF) | | |
| EXXSOL ™ D60 | solvent | Distillates (petroleum), hydrotreated light (CAS # 64742-47-8); |
| (Exxon) | | and Hydrocarbons, C10-C13, n-alkanes, isoalkanes, cyclics, <2% |
| | | aromatics (CAS # 64742-48-9) |
| MARMOLINA 20/40 | solid carrier | Calcium magnesium carbonate (CAS # 16389-88-1) |
| (Mexico Local) | | |
| Zinc oxide | drying agent | CAS # 1314-13-2 |
| Water | solvent | CAS # 7732-18-5 |
| EXXSOL ™ D110 | solvent | Distillates (petroleum), hydrotreated light (CAS # 64742-47-8) |
| (Exxon) | | |
| EXXSOL ™ D130 | solvent | Distillates (petroleum), hydrotreated middle (CAS # 64742-46-7) |
| (Exxon) | | |

### Example 1

### Caking Test

To a glass vial was added a sample of formulated product until the vial was two-thirds full. The vial was sealed with a lid and allowed to stand for 14 days at 54° C. The vial was then inverted to allow the free-flowing contents to fall toward the lid. Formulated product remaining at the bottom of the cylinder (i.e. product that did not flow) served as a visual estimate of caked material.

### Example 2

### Procedure for the Preparation of a Granular Formulation

Bifenthrin (4.0 g) was heated to a liquid state at 80° C. and mixed with Exxol™ D60 (2.5 g). The resultant mixture was slowly added to Marmolina 20/40 (984.4 g) while agitated in a vessel at ambient temperature. After the addition was complete, the agitated mixture was sprayed with a slurry of Sokalan R PA 25 CL PN (1.00 g), Agrocer Green 007 pigment (2.00 g) and a small amount of water (0.6 g). To the resultant mixture with continued agitation was added milled chlorantraniliprole (2.5 g) followed by a portionwise addition of Tixosil® 38AB (3.00 g). Agitation was continued until the mixture was homogenous. The resultant mixture was screened on a 40-mesh screen to remove fines, yielding a granular formulation. A sample was tested for caking, as in Example 1.

### Example 3

### Alternate Procedure for the Preparation of a Granular Formulation

Bifenthrin (4.0 g) was heated to a liquid state at 80° C. and mixed with Exxol™ D60 (2.5 g). The resultant mixture was slowly added to Marmolina 20/40 (984.4 g) while agitated in a vessel at ambient temperature. After the addition was complete, the agitated mixture was sprayed with a slurry of Sokalan R PA 25 CL PN (1.00 g), Agrocer Green 007 pigment (2.00 g), milled chlorantraniliprole (2.5 g) and water (0.6 g). Agitation was continued until the mixture was homogenous. Tixosil® 38AB (3.00 g) was added portionwise to the agitated mixture. Agitation was continued until the mixture became homogenous. The resultant mixture was screened on a 40-mesh screen to remove fines, yielding a granular formulation. A sample was tested for caking, as in Example 1.

### Example 4

### Preparation of a Granular Formulations

Granular formulations were prepared, as in Example 2, in Experiments 1-22, using the parameters in Tables B-D below. The homogeneity of each experiment was determined by a visualization of the colorant distribution once mixing was complete. A test for caking was conducted, as in Example 1, for the homogeneous mixtures of Experiments 1-15 and 19-22.

As can be observed in Experiments 19-22 less caking, resulting in improved solid flowability, occurred with the addition of a small amount of water as a second solvent to the mixture. As can be observed in Table D, the composition of Experiment 22 resulted in the least (i.e. 0%) amount of caking. This unexpected result of improved flowability characteristics lead to the utilization of minimal amounts of drying agents. This unexpected result also lead to an avoidance of an additional energy and time-consuming drying step to remove water, despite the addition of water to achieve a solid homogeneous non-caking composition.

The abbreviation “Exp.” stands for “experiment”. The abbreviation “wt %” stands for “weight percent”.

TABLE B

| Formulation Ingredient | Exp. 1 | Exp. 2 | Exp. 3 | Exp. 4 | Exp. 5 | Exp. 6 | Exp. 7 |
|---|---|---|---|---|---|---|---|
| Bifenthrin (wt %) | 0.40 | 0.40 | 0.40 | 0.40 | 0.40 | 0.40 | 0.40 |
| Chlorantraniliprole (wt %) | 0.25 | 0.25 | 0.25 | 0.25 | 0.25 | 0.25 | 0.25 |
| Agrocer ® Green 007 (wt %) | 0.30 | 0.30 | 0.30 | 0.30 | 0.30 | 0.30 | 0.30 |
| Tixosil ® 38AB (wt %) | 0.10 | 0.15 | 0.20 | 0.25 | 0.10 | 0.10 | 0.20 |
| Marmolina 20/40 (wt %) | Balance | Balance | Balance | Balance | Balance | Balance | Balance |
| | to 100 | to 100 | to 100 | to 100 | to 100 | to 100 | to 100 |
| Sokalan ® PA 25 CL PN (wt %) | 0.20 | 0.20 | 0.20 | 0.20 | 0.15 | 0.10 | 0.10 |
| Exxsol ™ D60 (wt %) | 0.40 | 0.40 | 0.40 | 0.40 | 0.40 | 0.40 | 0.40 |
| Homogeneous Mixture | Yes | Yes | Yes | Yes | Yes | Yes | Yes |
| Amount of Caking | >50% | >50% | >50% | >50% | <50% | <50% | <50% |

TABLE C

| Formulation Ingredient | Exp. 8 | Exp. 9 | Exp. 10 | Exp. 11 | Exp. 12 | Exp. 13 | Exp. 14 | Exp. 15 |
|---|---|---|---|---|---|---|---|---|
| Bifenthrin (wt %) | 0.40 | 0.40 | 0.40 | 0.40 | 0.40 | 0.40 | 0.40 | 0.40 |
| Chlorantraniliprole | 0.25 | 0.25 | 0.25 | 0.25 | 0.25 | 0.25 | 0.25 | 0.25 |
| (wt %) | | | | | | | | |
| Agrocer ® Green 007 | 0.30 | 0.30 | 0.30 | 0.30 | 0.30 | 0.30 | 0.30 | 0.20 |
| (wt %) | | | | | | | | |
| Zinc oxide (wt %) | — | 0.40 | — | — | — | — | — | 0.40 |
| Tixosil ® 38AB (wt %) | 0.15 | 0.10 | 0.50 | 0.10 | 0.10 | 0.10 | 0.50 | 0.10 |
| Marmolina 20/40 | Balance | Balance | Balance | Balance | Balance | Balance | Balance | Balance |
| (wt %) | to 100 | to 100 | to 100 | to 100 | to 100 | to 100 | to 100 | to 100 |
| Sokalan ® PA 25 CL | 0.15 | 0.20 | 0.20 | 0.20 | 0.20 | 0.20 | 0.20 | 0.10 |
| PN (wt %) | | | | | | | | |
| Exxsol ™ D60 (wt %) | 0.40 | 0.40 | 0.40 | 0.30 | — | — | 0.20 | 0.20 |
| Exxsol ™ D110 (wt %) | — | — | — | — | 0.30 | — | — | — |
| Exxsol ™ D130 (wt %) | — | — | — | — | — | 0.30 | — | — |
| Homogeneous | Yes | Yes | Yes | Yes | Yes | Yes | Yes | Yes |
| Mixture | | | | | | | | |
| Amount of Caking | <50% | >50% | <25% | >50% | >50% | >50% | <25% | 0% |

TABLE D

| Formulation Ingredient | Exp. 16 | Exp. 17 | Exp. 18 | Exp. 19 | Exp. 20 | Exp. 21 | Exp. 22 |
|---|---|---|---|---|---|---|---|
| Bifenthrin (wt %) | 0.40 | 0.40 | 0.40 | 0.40 | 0.40 | 0.40 | 0.40 |
| Chlorantraniliprole | 0.25 | 0.25 | 0.25 | 0.25 | 0.25 | 0.25 | 0.25 |
| (wt %) | | | | | | | |
| Agrocer ® Green 007 | 0.20 | 0.20 | 0.20 | 0.20 | 0.20 | 0.20 | 0.20 |
| (wt %) | | | | | | | |
| Water (wt %) | — | — | — | 0.06 | 0.06 | 0.06 | 0.06 |
| Tixosil ® 38AB (wt %) | 0.10 | 0.10 | 0.20 | 0.10 | 0.20 | 0.30 | 0.30 |
| Marmolina 20/40 | Balance | Balance | Balance | Balance | Balance | Balance | Balance |
| (wt %) | to 100 | to 100 | to 100 | to 100 | to 100 | to 100 | to 100 |
| Sokalan ® PA 25 CL | 0.10 | 0.10 | 0.10 | 0.10 | 0.10 | 0.10 | 0.10 |
| PN (wt %) | | | | | | | |
| Exxsol ™ D60 (wt %) | 0.20 | 0.30 | 0.20 | 0.30 | 0.20 | 0.30 | 0.25 |
| Homogeneous Mixture | No | No | No | Yes | Yes | Yes | Yes |
| Amount of Caking | — | — | — | <25% | <25% | <25% | 0% |

### BIOLOGICAL EXAMPLES

The following tests demonstrate the control efficacy of compounds of this disclosure on specific pests. “Control efficacy” represents inhibition of invertebrate pest development (including mortality) that causes significantly reduced feeding. The pest control protection afforded by the compounds is not limited, however, to these species. The term “g ai/ha” means grams of active ingredient per hectare. The term “DAA” means days after application. The term “DAI” means days after infestation. The term “DAP” means days after planting.

### Test A

For evaluating control of white grub larvae (Phyllophaga spp.) under greenhouse conditions a test unit consisted of a 10 L, 30 cm diameter plastic pot filled with a gleyic luvisol soil type, representative of the corn growing areas of Tepatitlan Jalisco in West Mexico. A single 4 cm deep planting hole was made in the center of the pot. A formulated test composition was placed in the planting hole. One corn (Zea Mays) seed was immediately placed on top of the formulated test composition and covered with soil to simulate an in-furrow granule application. At 5 cm distances lateral to the center planting hole, five additional holes were made in each pot. Each of the five holes were artificially infested with one 1st instar white grub larvae and covered with soil. The pot was watered to soil capacity and held under greenhouse conditions at 25° C. with a 14/10 h daytime/night photoperiod until evaluated for efficacy.

The composition of Experiment 22 of Table C was tested at three treatment rates (97.5, 130, and 162.5 g ai/ha) and compared to the individual active ingredients of the composition at a rate equivalent to the 130 g ai/ha rate tested in the composition of Experiment 22 (i.e. bifenthrin (Brigadier® 0.3 G) at 75 g ai/ha and chlorantraniliprole (Coragen® 20 SC) at 50 g ai/ha). A standard insecticide chlorpyrifos (Lorsban® 5 G) at 1000 g ai/ha was included for comparison as well as an untreated check with no chemical application. Treatments were applied as a dry granule formulation, except for chlorantraniliprole, which was a liquid formulation of 200 g ai/liter. The chlorantraniliprole liquid formulation was diluted with water to an equivalent in-furrow application of 200 liters/ha and poured in the planting hole in place of the granules. The treatment compositions evaluated for the control of white grub larvae are described in Table 1.

TABLE 1
Application test rates for the control of white grub larvae
(Phyllophaga spp.) in corn under greenhouse conditions.

| Treatment | | Composition Active Ingredient |
|---|---|---|
| Number | Composition | Description (g ai/ha) |
| A1 | Test Composition 1 | Chlorantraniliprole (37.5) and |
| | | Bifenthrin (60) |
| A2 | Test Composition 2 | Chlorantraniliprole (50) and |
| | | Bifenthrin (80) |
| A3 | Test Composition 3 | Chlorantraniliprole (62.5) and |
| | | Bifenthrin (100) |
| A4 | Briadier ® 0.3 G insect | Bifenthrin (75) |
| | control formulation | |
| A5 | Coragen ® 20 SC insect | Chlorantraniliprole (50) |
| | control formulation | |
| A6 | Lorsban ® 5 G insect | Chlorpirifos (1000) |
| | control formulation | |
| A7 | Untreated check | No Active Ingredient |

Efficacy evaluations were made at 10, 20, 30 and 40 days after planting. Four replications consisting of two pots each were conducted per treatment per the four evaluation dates for a total of 32 pots per treatment. At each evaluation interval, eight pots per treatment were removed to assess root damage and the average number of surviving white grub larvae in each pot. Data were analyzed using Analysis of Variance (ANOVA), and means were compared using Duncan's Multiple Range Test (DMRT).

To determine the number of surviving white grub larvae, soil was removed from each pot being evaluated. The soil was spread on a 1 m² sheet of black plastic, and the surviving white grub larvae were counted. The average number of white grub larvae per pot were calculated and are shown in Table 2.

Test Compositions 2 and 3 demonstrated an average of fewer surviving white grub larve at 30 days after application compared to bifenthrin alone, chlorantraniliprole alone and chlorpyrifos. At 40 days after application, Test Compositions 2 and 3 maintained better white grub larve control compared to bifenthrin alone and were similar to chlorantraniliprole alone and chlorpyrifos.

TABLE 2
Average number of surviving white grub larvae (Phyllophaga spp.) per plant/pot.

| Treatment | 10 | | 20 | | 30 | | 40 | |
|---|---|---|---|---|---|---|---|---|
| Number | DAA | DMRT | DAA | DMRT | DAA | DMRT | DAA | DMRT |
| A1 | 3.1 | bc | 1.8 | b | 2.3 | b | 1.9 | b |
| A2 | 3.4 | bc | 2.5 | b | 0.9 | c | 0.5 | c |
| A3 | 3.5 | bc | 2.8 | b | 1 | c | 0.6 | c |
| A4 | 4.1 | ab | 2.3 | b | 1.9 | bc | 1.1 | bc |
| A5 | 2.4 | c | 2.3 | b | 1.5 | bc | 0.5 | c |
| A6 | 3.9 | ab | 1.8 | b | 1.57 | bc | 0.9 | c |
| A7 | 5 | a | 5 | a | 5 | a | 5 | a |

Root damage evaluations are shown in Table 3. Root damage was assessed using the Iowa 1-6 scale. For further information regarding the Iowa 1-6 scale, see Journal of Economic Entomology 1971, 64 (3), 764-765; and Journal of Economic Entomology 2005, 98 (1), 1-8, and references cited therein. Corn roots were pulled from the soil, cut from the stem and washed in a container with water containing a 0.5% non-ionic surfactant. Each clean root was evaluated using the following scale:
1. no damage or only a few minor feeding scars;
2. feeding scars evident, but no roots eaten off to within 3.8 cm of the plant;
3. several roots eaten off to within 3.8 cm of the plant, but never the equivalent of an entire node of roots destroyed;
4. one node of roots completely destroyed;
5. two nodes of roots completely destroyed; and
6. three or more nodes of roots destroyed.

Test Composition 3 (i.e. the highest rate) demonstrated less root damage at 30 days after application compared to bifenthrin alone and chlorpyrifos. At 40 days after application, Test Compositions 1, 2 and 3 (i.e. all three rates) demonstrated numerically less root damage compared to bifenthrin alone, chlorantraniliprole alone and chlorpyrifos.

TABLE 3
Root damage index ratings (using the Iowa 1-6 scale) of plants
exposed to white grub larvae (Phyllophaga spp.).

| Treatment | 10 | | 20 | | 30 | | 40 | |
|---|---|---|---|---|---|---|---|---|
| Number | DAA | DMRT | DAA | DMRT | DAA | DMRT | DAA | DMRT |
| A1 | 1.5 | b | 2.4 | bc | 2.6 | bc | 2.3 | bcd |
| A2 | 1.5 | b | 2.1 | bc | 2.3 | bc | 1.8 | cd |
| A3 | 1 | b | 2.3 | bc | 1.9 | c | 1.5 | d |
| A4 | 1.3 | b | 2.4 | bc | 3.5 | ab | 3.3 | b |
| A5 | 1.5 | b | 2.8 | b | 2.4 | bc | 2.6 | bcd |
| A6 | 1 | b | 1.9 | c | 2.9 | bc | 2.8 | bc |
| A7 | 2.5 | a | 3.6 | a | 4.8 | a | 5.3 | a |

### Test B

For evaluating control of fall armyworm (Spodoptera frugiperda) under greenhouse conditions a test unit consisted of a 10 L, 30 cm diameter plastic pot filled with a gleyic luvisol soil type, representative of the corn growing area of Tepatitlan Jalisco in West Mexico. A single 4 cm deep planting hole was made in the center of the pot. A formulated test composition was placed in the planting hole. One corn (Zea Mays) seed was immediately placed on top of the formulated test composition and covered with soil to simulate an in-furrow granule application. The pot was watered to soil capacity and held under greenhouse conditions at 25° C. with a 14/10 h daytime/night photoperiod throughout the test. Seven days after germination, the plant was artificially infested with one-1st instar fall armyworm larva.

The composition of Experiment 22 of Table C was tested at three treatment rates (97.5, 130, and 162.5 g ai/ha) and compared to the individual active ingredients of the composition at a rate equivalent to the 130 g ai/ha rate tested in the composition of Experiment 22 (i.e. bifenthrin (Brigadier® 0.3 G) at 75 g ai/ha and chlorantraniliprole (Coragen® 20 SC) at 50 g ai/ha). An untreated check with no chemical application was also included for comparison. Treatments were applied as a dry granule formulation, except for chlorantraniliprole, which was a liquid formulation of 200 g ai/liter. The chlorantraniliprole liquid formulation was diluted with water to an equivalent in-furrow application of 200 liters/ha and poured in the planting hole in place of the granules. The treatment compositions evaluated for the control of white grub larvae are described in Table 4.

TABLE 4
Application test rates for control of fall armyworm (Spodoptera
frugiperda) in corn under greenhouse conditions.

| Treatment | | Composition Active Ingredient |
|---|---|---|
| Number | Composition | Description (g ai/ha) |
| B1 | Test composition 1 | Chlorantraniliprole (37.5) and |
| | | Bifenthrin (60) |
| B2 | Test composition 2 | Chlorantraniliprole (50) and |
| | | Bifenthrin (80) |
| B3 | Test composition 3 | Chlorantraniliprole (62.5) and |
| | | Bifenthrin (100) |
| B4 | Briadier ® 0.3 G insect | Bifenthrin (75) |
| | control formulation | |
| B5 | Coragen ® 20 SC insect | Chlorantraniliprole (50) |
| | control formulation | |
| B6 | Untreated check | No Active Ingredient |

Efficacy evaluations were made at 3, 5 and 10 days after the plants were artificially infested with Fall Armyworm. Four replications consisting of ten pots (plants) each were conducted per treatment for a total of 40 pots per treatment. At each evaluation interval, the number of live fall armyworm larvae per pot (plant) were recorded, and plant damage was assessed using the Davis 1-9 scale as follows:
1. no damage to pinhole lessions present on whorl leaves;
2. pinholes and small circular lessions present on whorl leaves;
3. small circular lession and few small elongated (rectangular shaped) lessions of up to 1.3 cm in length present on whorl and/or furl leaves;
4. several small to mid-sized elongated lessions of 1.3 to 2.5 cm in length present on a few whorls and/or furl leaves;
5. several large elongated lessions greater than 2.5 cm in length present on a few whorls and furl leaves and/or a few small- to mid-sized uniform to irregular shaped holes (basement membrane consumed) eaten from the whorl and/or furl leaves;
6. several large elongated lessions present on several whorl and furl leaves and/or several large uniform to irregular shaped holes eaten from the whorl and furl leaves;
7. many elongated lessions of all sizes on several whorl leaves plus several large uniform to irregular shaped holes eaten from the whorl and furl leaves;
8. many elongated lessions of all sizes present on most whorl and furl leaves plus many mid- to large-sized uniform to irregular shaped holes eaten from the whorl and furl leaves; and
9. whorl and furl leaves almost totally destroyed.

Data were analyzed using Analysis of Variance (ANOVA), and means were compared using Duncan's Multiple Range Test (DMRT). Fall armyworm (Spodoptera frugiperda) larvae survival evaluations are shown in Tables 5 and 6.

TABLE 5
Average number of surviving fall armyworm
(Spodoptera frugiperda) larvae per plant/pot.

| Treatment | 3 | | 5 | | 10 | |
|---|---|---|---|---|---|---|
| Number | DAI | DMRT | DAI | DMRT | DAI | DMRT |
| B1 | 1 | a | 0.975 | a | 0.85 | a |
| B2 | 1 | a | 1 | a | 0.85 | a |
| B3 | 1 | a | 1 | a | 0.9 | a |
| B4 | 1 | a | 0.975 | a | 0.8 | a |
| B5 | 1 | c | 1 | a | 0.925 | a |
| B6 | 1 | a | 1 | a | 0.95 | a |

TABLE 6
Foliage damage index ratings (using Davis 1-9 scale) of plants
exposed to fall armyworm (Spodoptera frugiperda) larvae.

| Treatment | 3 | | 5 | | 10 | |
|---|---|---|---|---|---|---|
| Number | DAI | DMRT | DAI | DMRT | DAI | DMRT |
| B1 | 1.68 | a | 2 | a | 4.5 | a |
| B2 | 1.58 | a | 1.75 | a | 3.73 | a |
| B3 | 1.55 | a | 2.08 | a | 4.53 | a |
| B4 | 1.6 | a | 1.88 | a | 3.77 | a |
| B5 | 1.5 | a | 1.63 | a | 3.98 | a |
| B6 | 1.7 | a | 2.28 | a | 4.83 | a |

### Test C

For evaluating corn plant uptake of chlorantraniliprole and control of fall armyworm (Spodoptera frugiperda) under laboratory conditions each test unit consisted of a 2.5 inch pot filled part way with heat-pasteurized Woodstown soil. A single corn seed (Prairie Hybrid 2431) was placed in each pot. A formulated test composition was applied over the seed and covered with additional soil to simulate an in-furrow application. To the pot was added 25 mL of water. The pot was held in a Growth Chamber at 28° C. and 70% relative humidity with a 16/8 h daytime/night photoperiod throughout the test and watered as needed.

The granular composition of Experiment 22 of Table C was tested at 0.1 mg chlorantraniliprole ai/target seed and compared to a liquid formulation of chlorantraniliprole (Coragen® Insect Control) at 0.1 mg ai/target seed. An untreated check with no chemical application was also included for comparison. 40 mg of the granular composition of Experiment 22 of Table C was applied as the dry granule formulation. Chlorantraniliprole (Coragen® Insect Control), which was a liquid formulation was diluted with water to an equivalent in-furrow application of 100 ppm active ingredient and 1 mL was pipeted over the seed. The treatment compositions evaluated for the control of white grub larvae are described in Table 7.

TABLE 7
Application test rates for evaluating corn plant uptake of chlorantraniliprole and control
of fall armyworm (Spodoptera frugiperda) in corn under laboratory conditions.

| | | Amount of Formulated | | |
|---|---|---|---|---|
| Treatment | | Composition Applied | | Composition Active Ingredient |
| Number | Composition | Over the Target Seed | | Description (mg ai/target seed) |
| C1 | Test composition 1 | 40 | mg | Chlorantraniliprole (0.1) and |
| | | | | Bifenthrin (0.16) |
| C2 | Coragen ® Insect Control | 1 | mL | Chlorantraniliprole (0.1) |
| | (diluted to 100 ppm | | | |
| | in water) | | | |

| | | | |
|---|---|---|---|
| C3 | Untreated check | — | No Active Ingredient |

Thumb leaf (i.e. leaf 1) emergence occurred at 4 days after planting. Plants were sampled at 1, 4 and 7 days after thumb leaf emergence (i.e. 5, 8 and 11 days after planting). Ten replications consisting of one plant each were conducted per treatment. Each sample leaf was cut in half along the mid-vein (tip to base axis). One half of each sample leaf was used for evaluating corn plant uptake of chlorantraniliprole, and the other half was used to determine the control of fall armyworm.

For efficacy evaluations, a half leaf was placed on a plastic tray with agar (HIS Trays, Clear Pack, Franklin Park, IL) to prevent desiccation, infested with a 1-day old fall armyworm larva, and held in a Growth Chamber at 23-25° C. and 70% relative humidity with a 16/8 h daytime/night photoperiod throughout the test. Feeding damage and larval mortality were evaluated at four days after each leaf sample was artificially infested with Fall Armyworm. Data were analyzed using ANOVA and means were compared using Least Significant Difference (LSD). Fall armyworm (Spodoptera frugiperda) larvae survival evaluations are shown in Tables 8 and 9.

TABLE 8
Fall armyworm (Spodoptera frugiperda) larvae mortality (%) at
various days after planting (DAP) when exposed to leaves treated
at planting with in-furrow applications of Chlorantraniliprole.

| | Chlorantraniliprole | | Chlorantraniliprole | | | | Chlorantraniliprole | | | |
|---|---|---|---|---|---|---|---|---|---|---|
| | Treated Leafs at 5 DAP | | Treated Leafs at 8 DAP | | | | Treated Leafs at 11 DAP | | | |
| Treatment | Leaf | | Leaf | | Leaf | | Leaf | | Leaf | |
| Number | 1 | LSD | 1 | LSD | 3 | LSD | 1 | LSD | 4 | LSD |
| C1 | 90 | a | 100 | a | 100 | a | 100 | a | 100 | a |
| C2 | 100 | a | 100 | a | 100 | a | 100 | a | 100 | a |
| C3 | 0 | b | 15 | b | 8 | b | 5 | b | 11 | b |

TABLE 9
Fall armyworm (Spodoptera frugiperda) feeding damage (%) at various
days after planting (DAP) when exposed to leaves treated at planting
with in-furrow applications of Chlorantraniliprole.

| | Chlorantraniliprole | | Chlorantraniliprole | | | | Chlorantraniliprole | | | |
|---|---|---|---|---|---|---|---|---|---|---|
| | Treated Leafs at 5 DAP | | Treated Leafs at 8 DAP | | | | Treated Leafs at 11 DAP | | | |
| Treatment | Leaf | | Leaf | | Leaf | | Leaf | | Leaf | |
| Number | 1 | LSD | 1 | LSD | 3 | LSD | 1 | LSD | 4 | LSD |
| C1 | 6.1 | b | 0.2 | b | 0.8 | b | 0.5 | b | 0.6 | b |
| C2 | 0.3 | b | 0.2 | b | 0.3 | b | 0.0 | b | 0.3 | b |
| C3 | 94 | a | 75 | a | 90 | a | 87 | a | 80 | a |

For the quantification of chlorantraniliprole active ingredient moving from the roots to the foliage, each half leaf sample (˜0.1-0.3 g of leaf tissue) with two 0.25 in. steel balls were placed into a 2 mL bead mill vial (Bio Plas Inc, San Rafael, CA) and stored at a temperature of −80° C. for six weeks until analysis. Bead mill vials containing the plant samples were allowed to warm to room temperature and then shaken for one minute using a Mini-Beadbeater-96 (BioSpec Products Inc., Bartlesville, OK). After all plant tissues were macerated with no visible intact plant material, acetonitrile (1.0 mL) was added to each bead mill vial and shaken for another minute. Samples were centrifuged for 5 min. at 4,000 rpm on a Sorvall Super T21 or 5 min. at 14,000 rpm on an Eppendorf 5415C. Chlorantraniliprole in the extract supernatant fraction was quantitated on a Quattro Micro Triple Quadrupole mass spectrometer (Waters Corporation, Milford, MA) by LC/MS/MS against 0.005-1.5 mg L-1 analytical standards. Data were analyzed using ANOVA and means were compared using Least Significant Difference (LSD). Corn plant uptake of chlorantraniliprole is described in Table 10.

TABLE 10
Concentration of chlorantraniliprole at various days after planting (DAP) in corn
plants treated at planting with in-furrow applications of Chlorantraniliprole.

| | Chlorantraniliprole Leaf | | Chlorantraniliprole Leaf | | | | Chlorantraniliprole Leaf | | | |
|---|---|---|---|---|---|---|---|---|---|---|
| | Concentration at 5 DAP | | Concentration at 8 DAP | | | | Concentration at 11 DAP | | | |
| | (ug ai/g leaf) | | (ug ai/g leaf) | | | | (ug ai/g leaf) | | | |
| Treatment | Leaf | | Leaf | | Leaf | | Leaf | | Leaf | |
| Number | 1 | LSD | 1 | LSD | 3 | LSD | 1 | LSD | 4 | LSD |
| C1 | 0.18 | b | 0.82 | b | 0.13 | b | 1.08 | b | 0.06 | b |
| C2 | 0.61 | a | 1.95 | a | 0.51 | a | 2.20 | a | 0.23 | a |

What is claimed is:

1. A solid pesticidal composition comprising bifenthrin, a diamide insecticide and optionally at least one adjuvant, wherein
(a) the weight ratio of bifenthrin to the diamide insecticide on an active ingredient basis is from about 10:1 to about 1:10; and
(b) the diamide insecticide concentration is from about 0.01 wt. % to about 10 wt. % of the total weight of the composition.

2. The solid pesticidal composition of claim 1 wherein the weight ratio of bifenthrin to the diamide insecticide on an active ingredient basis is from about 5:1 to about 1:1.

3. The solid pesticidal composition of claim 1, wherein the diamide insecticide concentration is from about 0.19 wt. % to about 0.31 wt. % of the total weight of the composition and wherein the bifenthrin concentration is from about 0.30 wt. % to about 0.50 wt. % of the total weight of the composition.

4. The composition of claim 1, wherein the diamide insecticide is selected from chlorantraniliprole, cyantraniliprole, tetrachlorantraniliprole, bromoantraniliprole, dichlorantraniliprole, tetraniliprole, cyclaniliprole, cyhalodiamide and flubendiamide.

5. The composition of claim 4, wherein the diamide insecticide is chlorantraniliprole.

6. The composition of claim 4, wherein the diamide insecticide is cyantraniliprole.

7. The solid pesticidal composition of claim 1, wherein at least one additional adjuvant is selected from the group consisting of drying agents, thickening agents, wetting agents, solvents, sticking agents, dispersants, solid carriers, and combinations of any of the foregoing.

8. The solid pesticidal composition of claim 1, wherein the composition is a solid granule, and wherein the composition comprises:
(i) from about 0.30 wt. % to about 0.50 wt. % bifenthrin, and
(ii) from about 0.19 wt. % to about 0.31 wt. % chlorantraniliprole;
(iii) from about 0.05 wt. % to about 0.35 wt. % of a drying agent,
(iv) from about 0.15 wt. % to about 0.50 wt. % of a solvent,
(v) from about 0.05 wt. % to about 0.25 wt. % of a sticking agent,
and
(vi) at least 95 wt. % of a solid carrier.

9. The solid pesticidal composition of claim 8, wherein the composition is a solid granule, and wherein the composition comprises:
(i) about 0.40 wt. % bifenthrin, and
(ii) about 0.25 wt. % chlorantraniliprole;
(iii) from about 0.10 wt. % to about 0.30 wt. % of a drying agent,
(iv) from about 0.20 wt. % to about 0.40 wt. % of a solvent,
(v) from about 0.10 wt. % to about 0.20 wt. % of a sticking agent,
and
(vi) at least 97 wt. % of a solid carrier.

10. The solid pesticidal composition of claim 1, wherein at least one drying agent is selected from the group consisting of calcium silicate, calcium carbonate, talc, kaolin, bentonite, diatomaceous earth, fumed silica, precipitated silica, colloidal silica, amorphous silica, sodium aluminosilicate, microcrystalline cellulose, attapulgite clay, and combinations of any of the foregoing.

11. The solid pesticidal composition of claim 1, wherein at least one solvent is a hydrotreated light petroleum distillate.

12. The solid pesticidal composition of claim 1, wherein at least one sticking agent is selected from the group consisting polyvinyl alcohols, polyvinyl acetates, acrylic acids, polyacrylic acid, polyvinyl pyrrolidone, polyethylene oxide, copolymers of acrylic acid, salts thereof, and combinations of any of the foregoing.

13. The solid pesticidal composition of claim 1 wherein the composition is a dust, powder, granule, pellet, prill, pastille or tablet.

14. A solid pesticidal composition for protecting an organism from an invertebrate parasitic pest comprising a parasiticidally effective amount of a composition of claim 1.

15. The composition of claim 14, wherein the organism is an animal.

16. The composition of claim 14, wherein the organism is a plant.

17. The composition of claim 15 in a form for oral administration.

18. A method for controlling an invertebrate pest comprising contacting the invertebrate pest or its environment with a biologically effective amount of a composition of claim 1.

19. The method of claim 15 wherein the environment is selected from the group consisting of a plant, an animal and a seed.
